(19) United States
(12) Patent Application Publication
(10) Pub. No.: US 2025/0122027 A1
(43) Pub. Date: Apr. 17, 2025

(54) MERGING CONVEYOR SYSTEMS AND COMPONENTS THEREOF

(71) Applicant: Lewco, Inc., Sandusky, OH (US)

(72) Inventors: Gerald T. Guerra, Sandusky, OH (US); Albert E. Sparling, Ossineke, MI (US); Alexander Philip Brown, Genoa, OH (US); Jacob Groshek, Avon, OH (US)

(21) Appl. No.: 18/917,600

(22) Filed: Oct. 16, 2024

Related U.S. Application Data
(60) Provisional application No. 63/590,774, filed on Oct. 16, 2023.

(51) Int. Cl. B65G 47/68; B65G 13/00; B65G 21/20; B65G 47/28

(52) U.S. Cl. CPC B65G 47/681; B65G 13/00; B65G 21/2072; B65G 47/28; B65G 2047/685; B65G 2201/047

(57) ABSTRACT

A merge conveying system configured to receive packages from two or more upstream conveyors and merge the packages to a downstream conveyor. The merge conveying system includes a buffer guard rail configured to reduce package jams within the merge conveyor by providing a temporary overflow path for packages.

### RELATED APPLICATION

This application claims priority to U.S. Provisional Patent Application No. 63/590,774, filed on Oct. 16, 2023, and entitled “MERGING CONVEYOR SYSTEMS AND COMPONENTS THEREOF,” the entirety of which is incorporated herein by reference.

### TECHNICAL FIELD

The present application relates generally a merging conveyor and, more particularly, to a merging conveyor system configured to merge packages streams from two upstream conveyors in a manner to reduce package jams.

### BACKGROUND OF THE INVENTION

Merging conveyor systems may be used in conjunction with other conveyors as a part of an overall conveying operation to combine the flow of packages conveyed along two or more conveyors onto a single conveyor. Merging conveyor systems may combine the flow of two or more upstream conveyors (e.g., upstream of merging) into a single downstream conveyor (e.g., downstream of merging). For example, a merging conveyor system may be implemented in a receiving portion of a conveying operation to merge packages conveyed along conveyor segments from two or more receiving locations which may be separated by a distance. Conventionally, merging conveyors may be disposed at ground level (e.g., on frames and/or wheels) and/or at an elevated position, such as part of an overhead conveying system.

When packages are merged from multiple upstream conveyors, the packages may jam in the merging conveyor, such as when there is an increased flow and/or density (e.g., grouping or clumping) of packages from one or more of the upstream conveyors. During a jam, packages may pile up against each other across a width of the merging conveyor, preventing packages from being conveyed to the downstream conveyor. Jams may be disruptive to the conveying operation, such as by slowing down the throughput of the conveying system or stopping the conveying operation. For example, when a jam occurs, the entire conveying system may need to be stopped, personnel may need to be dispatched to clear the jam, and all the motors and drives may need to be restarted after the jam is cleared to resume operation. Additionally, jams may cause safety concerns in the conveying operation. For example, a jam may cause packages to become dislodged from the conveyors or cause personnel to go to potentially dangerous locations, such as overhead elevated positions, to clear the jam.

To reduce the frequency of jams in merging conveyors, some merging conveyor systems implement additional controls in an attempt to prevent jams. For example, some merging conveyor systems may utilize visual sensors coupled with the conveyors to detect and divert packages in an attempt to reduce jamming. Additionally, some merging conveyors may utilize mechanical parts or components, such as gates, in an attempt to temporarily block the flow of upstream conveyors to reduce jamming in the merge conveyor. However, such known methods of reducing jams in merging systems are costly, complex, difficult to implement, difficult to access, and introduce additional components which may fail or otherwise cause issues in the conveying operation. Additionally, such mechanisms may be difficult or impossible to implement in locations in which merging conveyors are implemented, such as due to lack of available space.

Therefore, it would be desirable to provide a cost-effective merging conveyor system that reduces and/or prevents jams when articles and/or packages are conveyed from upstream conveyors to a downstream conveyor.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 is a perspective view of a merge conveyor system according to one embodiment;

FIG. 2 is a top view of the merge conveyor system of FIG. 1;

FIG. 3 is a top view of a downstream portion of the merge conveyor system of FIG. 1;

FIG. 4 is a perspective view of the downstream portion of the merge conveyor system of FIG. 3;

FIG. 5 is a top view of an upstream portion of an exemplary merge conveyor system;

FIG. 6 is a top view of a downstream portion of the merge conveyor system of FIG. 5;

FIG. 7 is a top view of a downstream portion of the merge conveyor system of FIG. 5;

FIG. 8 is a perspective view of a downstream portion of the merge conveyor system of FIG. 5;

FIG. 9 is a perspective view of a downstream portion of the merge conveyor system of FIG. 5;

FIG. 10 is a perspective view of an exemplary guard rail for use with the merge conveyor system of FIG. 5;

FIG. 11 is a top view of the guard rail of FIG. 10;

FIG. 12 is a side view of the guard rail of FIG. 10;

FIG. 13 is a front view from an upstream end of the guard rail of FIG. 10;

FIG. 14 is a rear view from a downstream end of the guard rail of FIG. 10;

FIG. 15 is a perspective view of the guard rail of FIG. 10;

FIG. 16A is a top view of a second receiving section of a merging portion of the merge conveyor system of FIG. 1;

FIG. 16B is a top perspective view of the second receiving section of FIG. 16A;

FIG. 17A a top view of an exemplary singulation section and an exemplary alignment section for use with the merge conveyor system of FIG. 1;

FIG. 17B is a side top perspective view of the singulation section and the alignment section of FIG. 17A;

FIG. 18A is a perspective view of an exemplary singulation section of the merge conveyor system of FIG. 1;

FIG. 18B is a top view of the singulation section of FIG. 18A;

FIG. 19A is a perspective view of an exemplary alignment section of the merge conveyor system of FIG. 1;

FIG. 19B is a top view of the alignment section of FIG. 19A;

FIG. 20A is a top view of a top view of an exemplary first receiving section and an exemplary consolidating section of a merging portion of the merge conveyor system of FIG. 1;

FIG. 20B is a side top perspective view of the first receiving section and the consolidating section of FIG. 14A; and

FIG. 21 is a top schematic view of a merge conveyor system according to another embodiment.

### DETAILED DESCRIPTION

The following description refers to the accompanying drawings, which illustrate specific embodiments of the present disclosure. Other embodiments having different structures and operation do not depart from the scope of the present disclosure. The description and drawings are not intended to limit the scope of the invention in any manner.

“A” and “an” as used herein indicate “at least one” of the item is present; a plurality of such items may be present, when possible. As used herein, “substantially” means “to a considerable degree,” “largely,” or “proximately” as a person skilled in the art in view of the instant disclosure would understand the term. Spatially relative terms, such as “front,” “back,” “inner,” “outer,” “bottom,” “top,” “horizontal,” “vertical,” “upper,” “lower,” “side,” “up,” “down,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Described herein are various technologies pertaining to a merge conveyor system for merging packages conveyed from two or more upstream conveyors to a downstream conveyor. It will be understood that the term “packages” is not limited to boxes containing items, but also encompasses any items or articles which may be conveyed along a conveyor. The merge conveyor system includes a first upstream portion configured to receive packages from a first upstream conveyor and a second upstream portion configured to receive packages from a second upstream conveyor. The upstream portions may receive packages from the upstream conveyors in any flow configuration, such as in random package flows. The merge conveyor system also includes a merging portion configured to merge packages from the first and second upstream conveyors and convey the merged packages to a downstream conveyor. The merge conveyor system is configured to reduce jams of packages received from the first and second upstream conveyors. The merging portion of the merge conveyor system may include a guard rail configured to provide packages a temporary overflow path to prevent or alleviate jams in the merging portion. The first and second upstream portions of the merge conveyor system may be configured to singulate and align packages along an outside edge of the respective conveyor portion before the packages are merged in the merging portion. The merge conveyor system may also include one or more increased speed sections configured to increase the speed of packages conveyed along the increased speed sections to facilitate merging of packages.

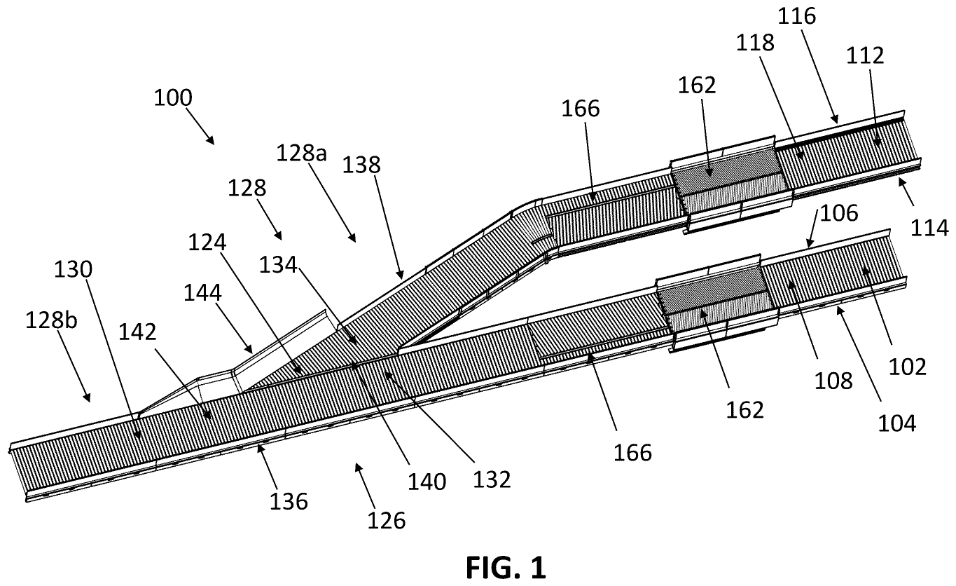

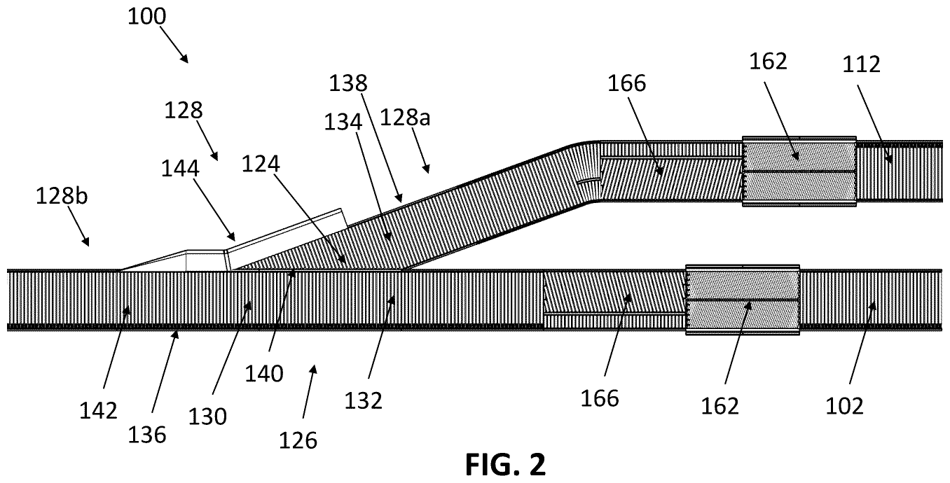

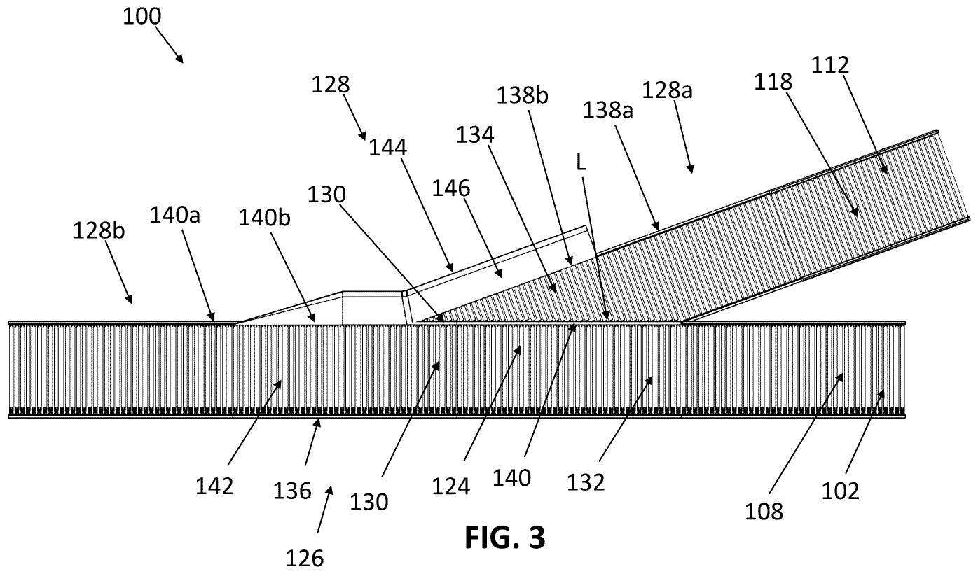

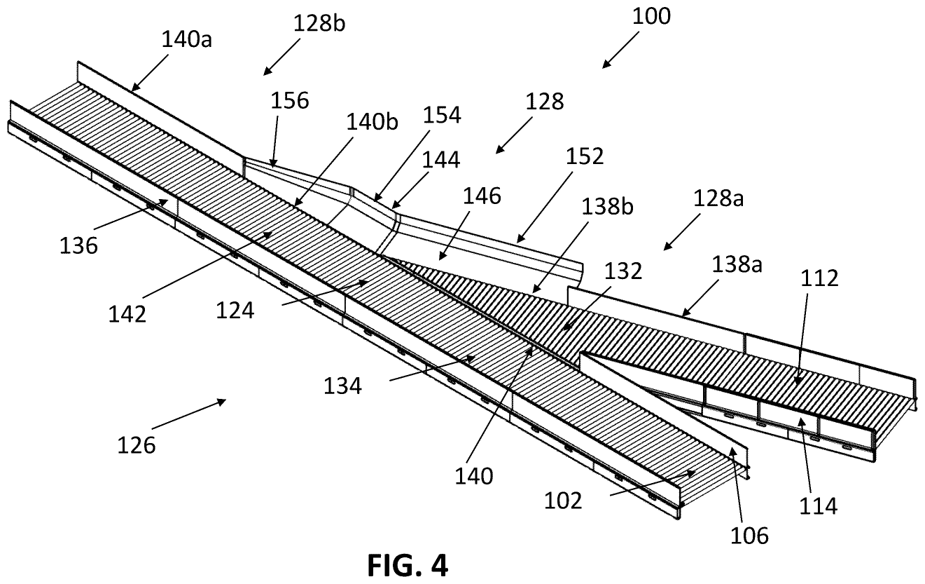

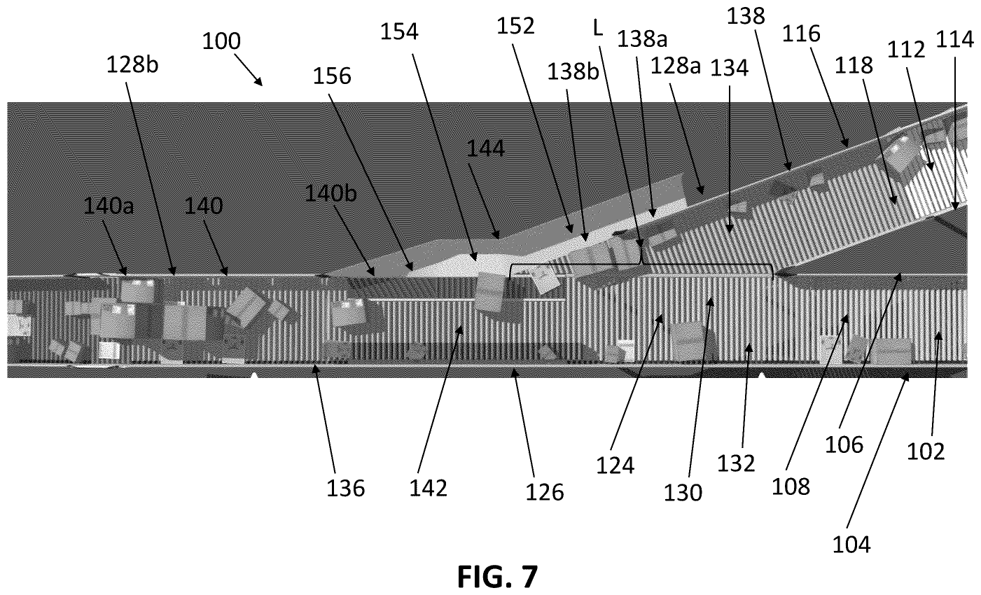

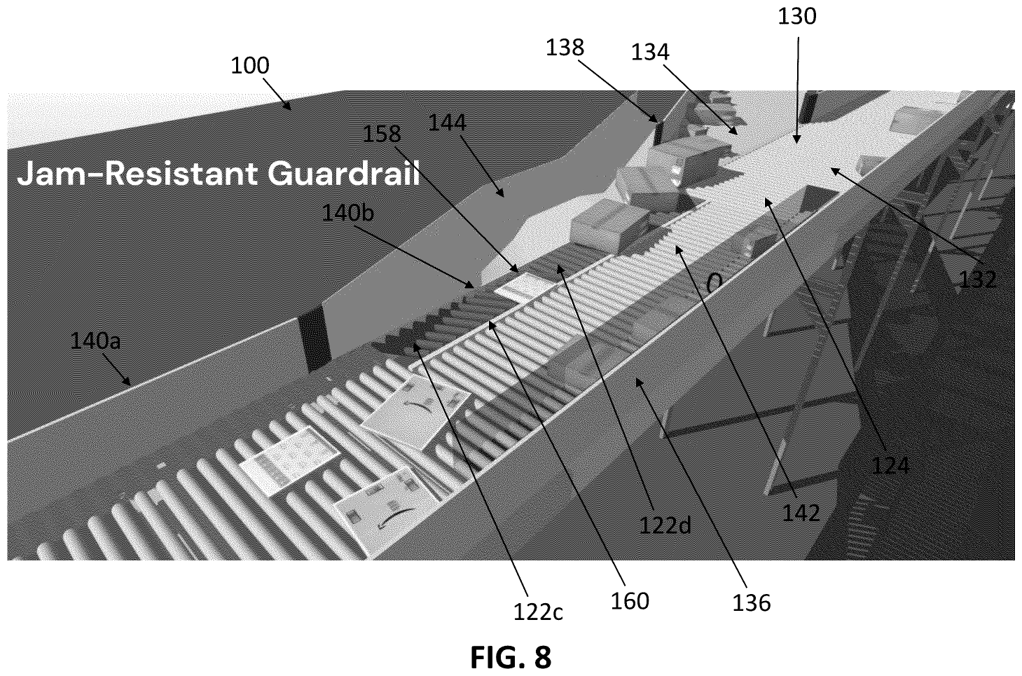

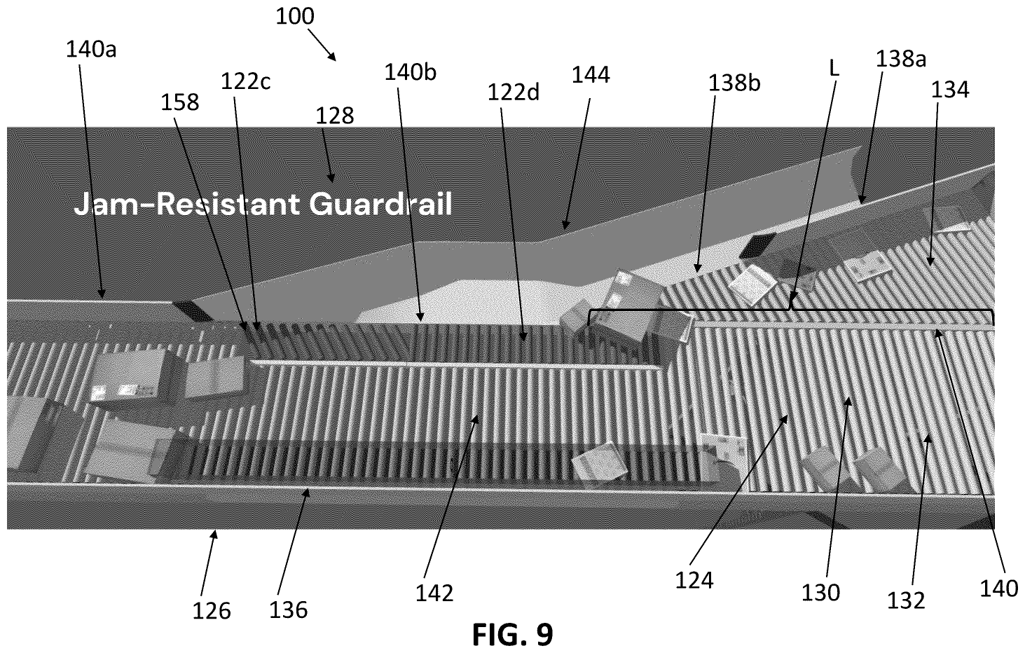

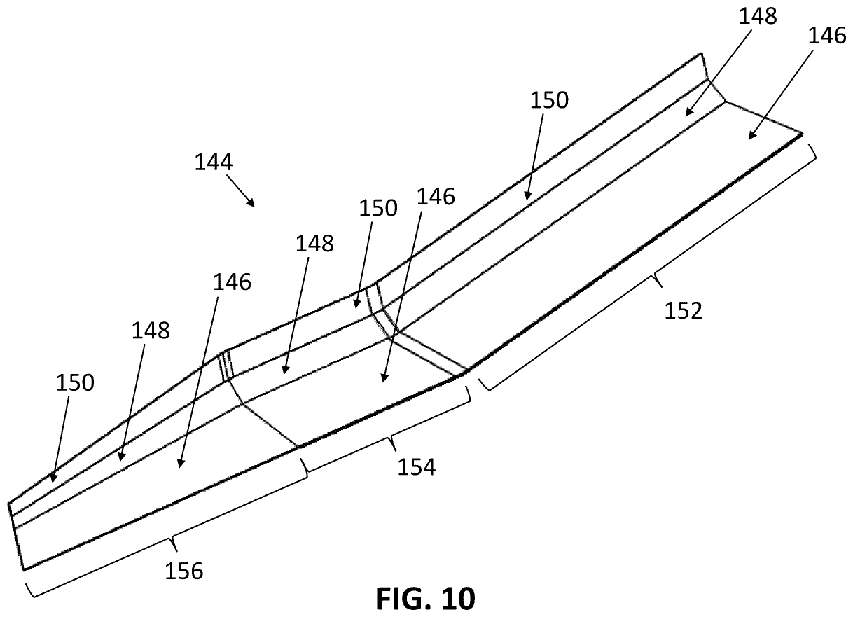

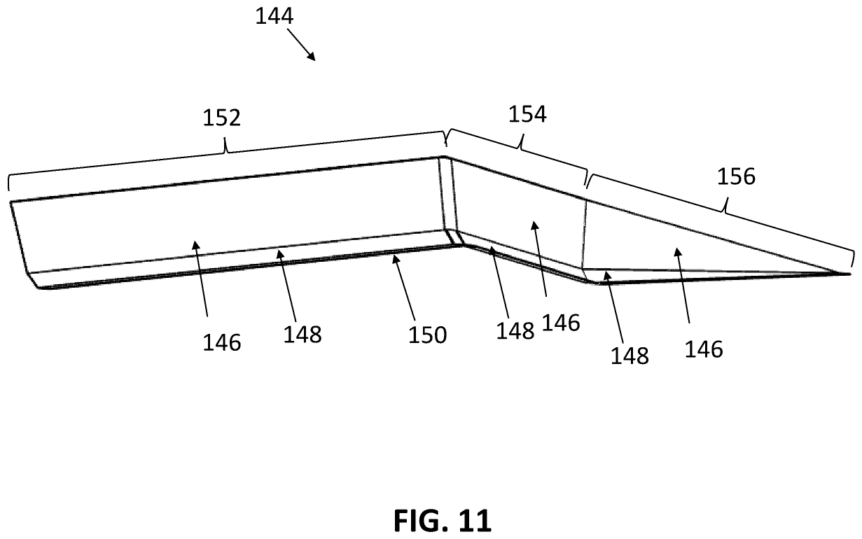

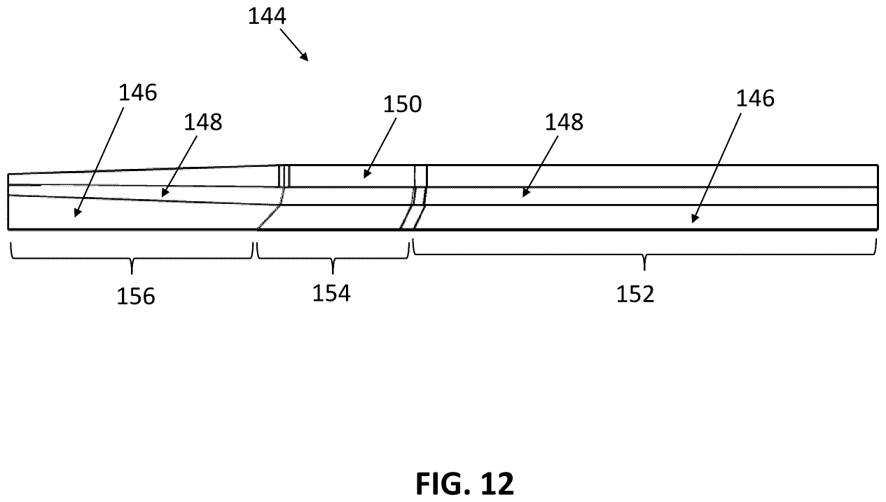

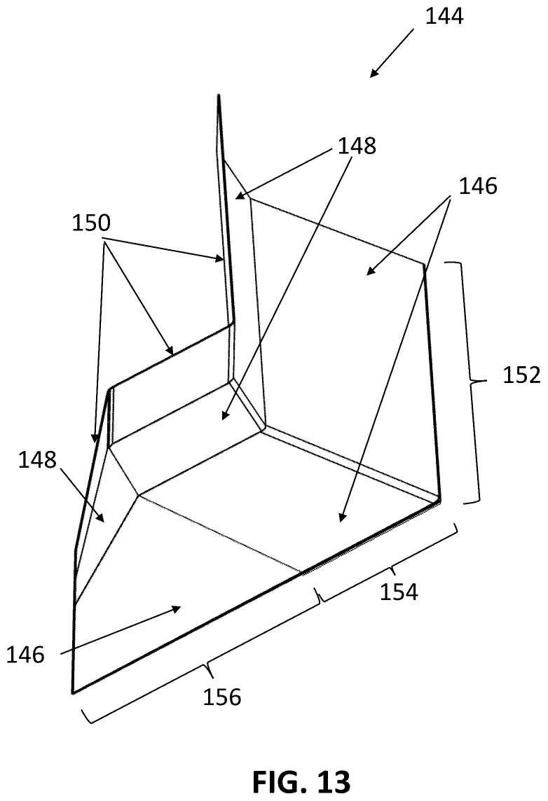

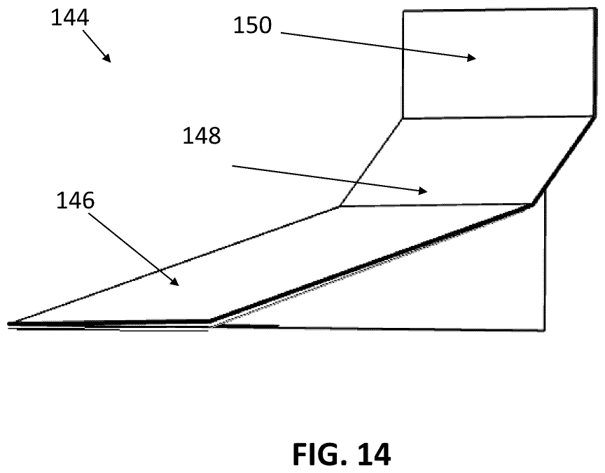

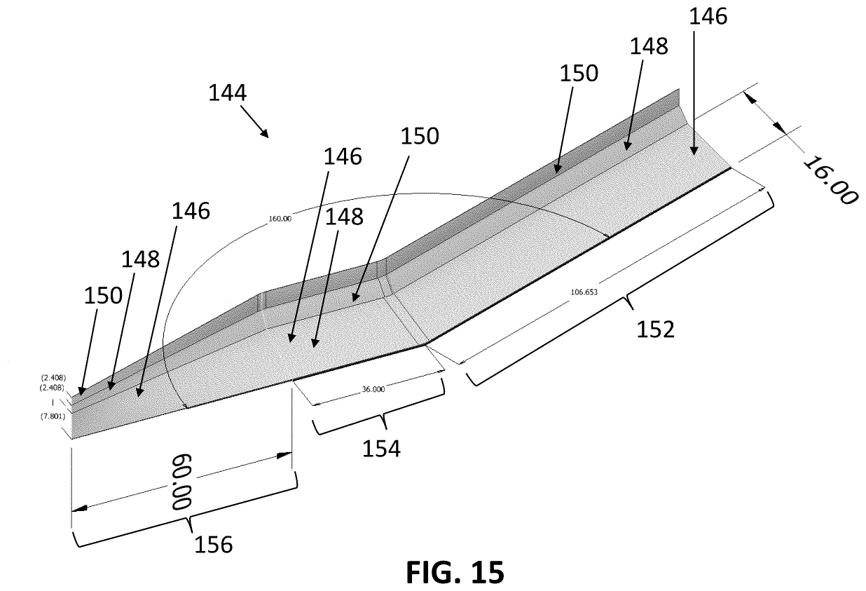

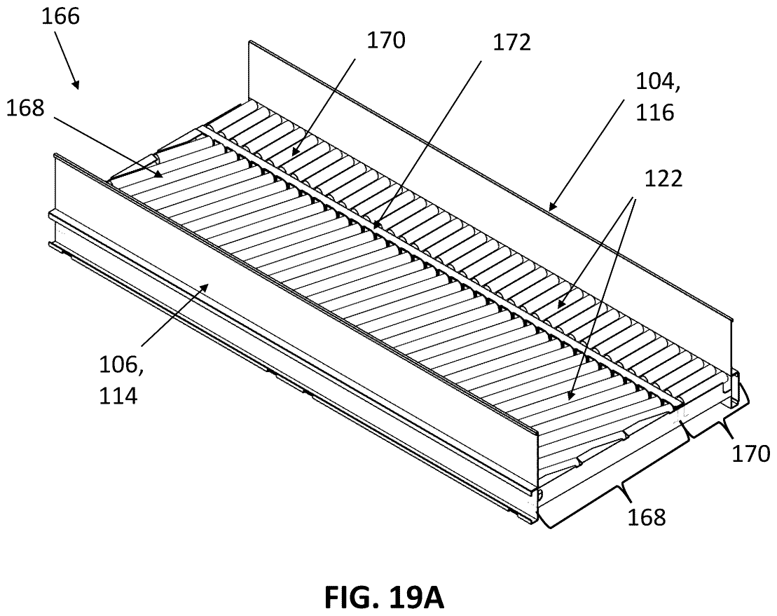

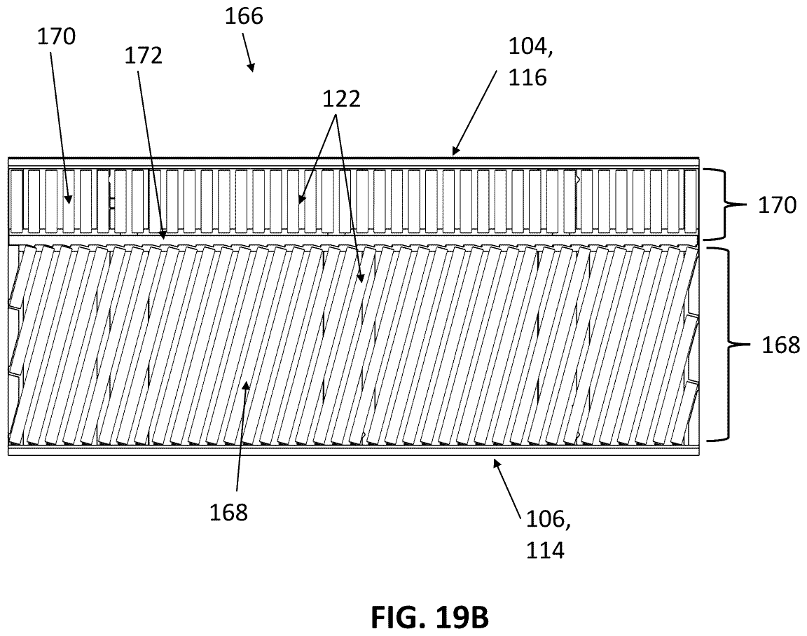

Referring to FIGS. 1-20B, a merge conveyor system 100 is depicted according to one embodiment. The conveyor system 100 is configured to be disposed downstream of first and second upstream conveyors and upstream of a downstream conveyor. The first upstream conveyor may be any suitable conveyor configured to convey packages from a first location toward the merge conveyor system. The second upstream conveyor may be any suitable conveyor configured to convey packages from a second location toward the merge conveyor. The merge conveyor system 100 includes a first upstream portion 102 configured to receive packages from the first upstream conveyor and a second upstream portion 112 configured to receive packages from the second upstream conveyor. The conveyor system 100 also includes a merging portion 124 configured to convey a single flow of packages to a downstream conveyor. The merging portion 124 is configured to receive packages from the first and second upstream portions 102, 112, merge the packages into a single flow of packages, and convey the merged packages to the downstream conveyor.

The first upstream portion 102 includes a first frame member 104 and a second frame member 106. In some embodiments, the first and second frame members 104, 106 are mounted on a plurality of legs that support the frame members 104, 106. In some embodiments, the legs are supported by wheels such that the first upstream portion 102 is movable on a surface (e.g., a floor). The first upstream portion 102 includes a first upstream conveying surface 108 extending a length of the first upstream portion 102 between the first and second frame members 104, 106. The first upstream conveying surface 108 is configured to convey packages from the first upstream conveyor to the merging portion 124. The first and second frame members 104, 106 may extend to a height greater than the first upstream conveying surface 108 such that the first and second frame members 104, 106 may act as guide rails for the first upstream portion 102 which prevent packages from being conveyed laterally off the first upstream conveying surface 108.

The second upstream portion 112 includes a first frame member 114 and a second frame member 116. In some embodiments, the first and second frame members 114, 116 are mounted on a plurality of legs that support the frame members 114, 116. In some embodiments, the legs are supported by wheels such that the second upstream portion 112 is movable on a surface (e.g., a floor). The second upstream portion 112 includes a second upstream conveying surface 118 extending a length of the second upstream portion 112 between the first and second frame members 114, 116. The second upstream conveying surface 118 is configured to convey packages from the second upstream conveyor 112 to the merging portion 124. The first and second frame members 114, 116 may extend to a height greater than the second upstream conveying surface 118 such that the first and second frame members 114, 116 may act as guide rails for the second upstream portion 112 which prevent packages from being conveyed laterally off the second upstream conveying surface 118.

The upstream ends of the first and second upstream portions 102, 112 may be spaced apart laterally and the first and second upstream portions 102, 112 may be sized, shaped, and configured such that the downstream ends of the first and second upstream portions 102, 112 merge together. The first and second upstream portions 102, 112 may merge together such that the second frame member 106 of the first upstream portion 102 and the first frame member 114 of the second upstream portion 112 merge or otherwise come together. The second frame member 106 of the first upstream portion 102 and the first frame member 114 of the second upstream portion 112 may terminate where the second frame member 106 of the first upstream portion 102 and the first frame member 114 of the second upstream portion 112 merge or otherwise come together. In the illustrated embodiment, the conveyor system 100 includes a V-shaped guard rail defining the terminus of the second frame member 106 of the first upstream portion 102 and the first frame member 114 of the second upstream portion 112. However, it will be understood that the conveyor system 100 may have other configurations. For example, the second frame member 106 of the first upstream portion 102 and the first frame member 114 of the second upstream portion 112 may each terminate near to location where the second frame member 106 of the first upstream portion 102 and the first frame member 114 of the second upstream portion 112 would intersect, such as close enough to prevent packages from moving between the second frame member 106 of the first upstream portion 102 and the first frame member 114 of the second upstream portion 112.

The first frame member 104 of the first upstream portion 102 and the second frame member 116 of the second upstream portion 112 may be spaced apart from the merging location of the second frame member 106 of the first upstream portion 102 and the first frame member 114 of the second upstream portion 112 on opposite sides of the first and second upstream conveying surfaces 108, 118, respectively. The first frame member 104 of the first upstream portion 102 and the second frame member 116 of the second upstream portion 112 may extend downstream of the merging location of the second frame member 106 of the first upstream portion 102 and the first frame member 114 of the second upstream portion 112, such as to define sides of the merging portion 124, and such that the first and second upstream conveying surfaces 108, 118 extend into the merging portion 124, as discussed below.

The first and second upstream portions 102, 112 may be configured in a variety of ways to convey packages from the first and second upstream conveying surfaces 108, 118, respectively, to the merging portion 124. In some embodiments, the first and second upstream portions 102, 112 include a plurality of spaced apart, rotatable cylindrical rollers 122 at least partially defining the upstream conveying surfaces 108, 118 and configured to move objects along the first and second upstream conveying surfaces 108, 118. The rollers 122 may extend at least partially between the respective first frame members 104, 114 and second frame members 106, 116. The rollers 122 may be rotatable to convey packages along the first and second upstream conveying surfaces 108, 118. The rollers 122 may be free-rotating rollers and may be driven by gravity and/or by a belt, chains, motors, or other drive mechanism(s), or any combination thereof. In the illustrated embodiment, the rollers 122 are driven such that the rollers 122 convey packages along the first and second upstream conveying surfaces 108, 118 toward the merging portion 124.

While the conveyor system 100 has been described as including a plurality of tubular rollers 122, it will be understood that the conveyor system 100 may have other configurations. For example, all or portions of the conveyor system 100 may include other conveying means, such as continuous belts, slat conveyors, skate wheels, chutes, or the like, or any combination thereof.

The merging portion 124 of the conveyor system 100 is disposed downstream of the first and second upstream portions 102, 112 and upstream of a downstream conveyor. The merging portion 124 is configured to receive packages from both the first and second upstream portions 102, 112, merge the packages into a single stream of packages, and convey the received packages to the downstream conveyor. The merging portion 124 may also be configured to prevent or otherwise reduce the jamming of packages received from the first and second upstream portions 102, 112 in the merging portion 124.

The merging portion 124 is generally V- or Y-shaped and configured to funnel packages received upstream from the first and second upstream portions 102, 112 into a single downstream flow of packages. The merging portion 124 has a first side 126, a second side 128 substantially opposite the first side 126, and a merge conveying surface 130 extending between the first and second sides 126, 128. The first side 126 may be substantially straight and extend from the first frame member 104 of the first upstream portion 102. The second side 128 is V-shaped or otherwise angled with an upstream portion 128a and a downstream portion 128b. The upstream portion 128a of the second side 128 extends substantially straight from (e.g., in substantially the same direction as) the second frame member 116 of the second upstream portion 112. The downstream portion 128b of the second side 128 extends downstream at an angle from the upstream portion 128a from a point substantially parallel to the first side 126 and substantially in line with the downstream end of the second frame member 106 of the first upstream portion 102. The second frame member 116 of the second upstream portion 112 may extend at least partially downstream of the terminus of the first frame member 114 of the second upstream portion 112 toward the downstream portion 128b of the second side 128 of the merging portion 124. The second frame member 116 of the second upstream portion 112 may define at least a portion of the upstream portion 128a of the second side 128 of the merging portion 124. The first frame member 104 of the first upstream portion 102 may extend along or define the first side 126 of the merging portion 124.

The merge conveying surface 130 extends between the second side 128 and the first side 126 of the merging portion 124 and may be substantially Y-shaped. The merging portion 124 may comprise a plurality of rollers 122 defining the merge conveying surface 130 and configured to convey packages downstream. The merge conveying surface 130 is configured to merge packages from the first and second upstream portions 102, 112 and convey the packages downstream to the downstream conveyor. The merging portion 124 and/or the merge conveying surface 130 may include one or more sections or subsections configured to facilitate the merging of packages from the first and second upstream portions 102, 112 into a single flow of packages, as discussed below. The merging portion 124 includes a plurality of rollers 122 extending at least partially between the first and second sides 126, 128. The top surfaces of the rollers 122 may define the merge conveying surface 130. The rollers 122 may be driven such that packages are conveyed downstream from the first and second upstream portions 102, 112 to the downstream conveyor.

In some embodiments, the first and second upstream portions 102, 112 and the merging portion 124 are disposed at the same height and are substantially level. The first and second upstream portions 102, 112 and the merging portion 124 may be disposed at a height accessible to a user standing on the ground, may be disposed overhead, or at any suitable height. However, it will be understood that the conveyor system 100 may have other configurations. For example, some or all of the first and/or second upstream portions 102, 112 and/or the merging portion 124 may be inclined or declined. For example, portions of the first and second upstream portions 102, 112 and the merging portion 124 may include a decline such that portions of the first and second upstream portions 102, 112 and the merging portion 124 convey the packages at least in part via gravity.

The first and second upstream conveying surfaces 108, 118 may extend into the merging portion 124 of the conveyor system 100 such that downstream portions of the first and second conveying surfaces 108, 118 define upstream portions of the merge conveying surface 130. The downstream ends of the first and second upstream portions 102, 112 are angled relative to one another such that downstream portions of the first and second conveying surfaces 108, 118 are substantially adjacent in the merging portion 124. In some embodiments, the downstream ends of the first and second upstream portions 102, 112 are oriented, positioned, or otherwise disposed such that packages conveyed along the first conveying surface 108 remain on the first conveying surface 108 into the merging portion 124 and that packages conveyed along the second conveying surface 118 remain on the second conveying surface 118 into the merging portion 124.

The downstream ends of the first and second conveying surfaces 108, 118 may come together within the merging portion 124 along an intersection length L. The first and second upstream portions 102, 112 may be oriented relative to one another to increase the length of the intersection length L. The length of the intersection length L may be increased to provide a greater length along which packages from the second upstream portion 112 may merge with packages from the first upstream portion 102. The greater length for merging packages from the first and second upstream portions 102, 112 may provide more space for packages to move around each other on the merge conveying surface 130 and may reduce jamming within the merging portion 124. The second upstream portion 112 may be angled relative to the first upstream portion 102 such that an intersection angle between the first and second upstream conveying surfaces 108, 118 (e.g., the angle of the merge of the first and second upstream portions 102, 112) is between about 5 degrees and about 50 degrees, such as between about 10 degrees and about 30 degrees, such as about 20 degrees.

The merging portion 124 may include one or more sections or subsections configured to facilitate the conveyance of packages from the first and second upstream portions 102, 112 to the downstream conveyor. The section(s) and/or subsection(s) may be configured to align and/or orient packages conveyed from the first and second upstream portions 102, 112 to prevent or otherwise reduce package jams in the merging portion 124. The upstream end of the merging portion 124 may be configured to direct packages from the first upstream conveying surface 108 toward the downstream conveyor. The upstream end of the merging portion 124 may also be configured to direct packages from the second upstream conveying surface 118 toward and/or onto the first upstream conveying surface 108 along at least a portion of the intersection length L.

The upstream end of the merging portion 124 may include a first receiving section 132 downstream of the terminus of the second frame member 106 of the first upstream portion 102 and near the first side 126 of the merging portion 124. The first receiving section 132 may be configured and positioned to receive packages conveyed along the first upstream portion 102. The first receiving section 132 may be a continuation or a part of the first upstream conveying surface 108 such that the first conveying surface 108 extends at least partially into the merging portion 124. The first receiving section 132 may be configured to receive packages from the first upstream portion 102 and convey the packages in a substantially straight line toward the downstream conveyor.

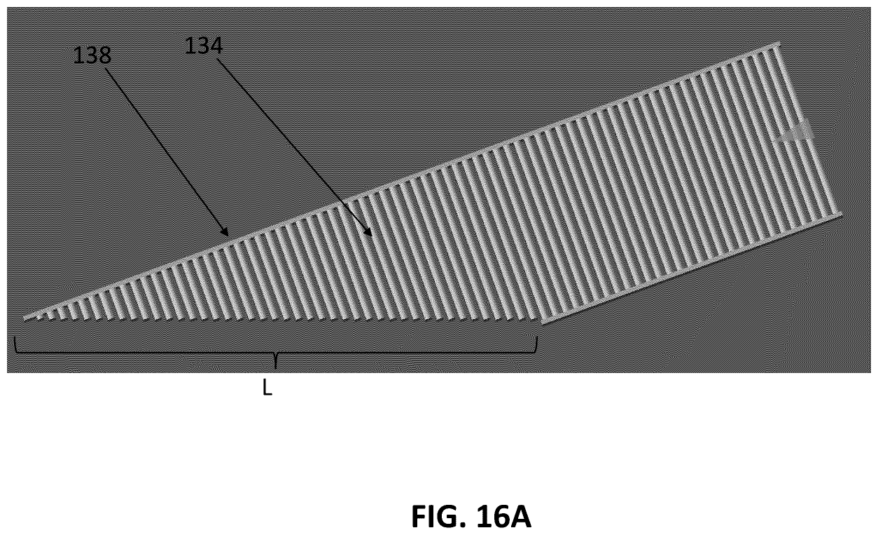

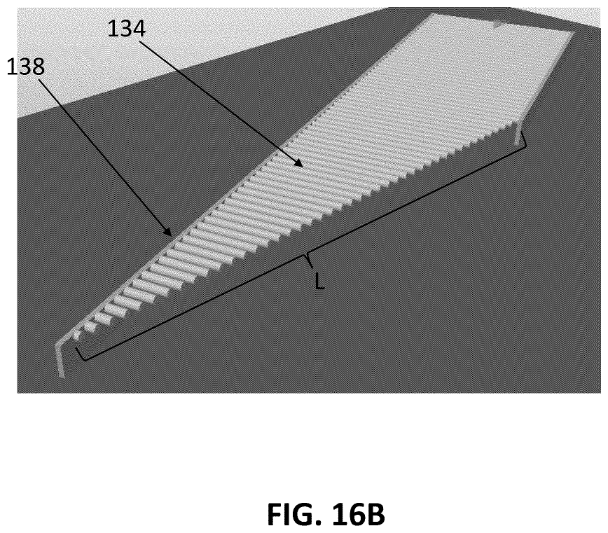

The upstream end of the merging portion 124 may also include a second receiving section 134 downstream of the terminus of the first frame member 114 of the second upstream portion 112 and near the upstream portion 128a of the second side 128 of the merging portion 124. The second receiving section 134 may be configured and positioned to receive packages conveyed along the second upstream portion 104. The second receiving section 134 may be a continuation or a part of the second upstream conveying surface 118 such that the second upstream conveying surface 118 extends at least partially into the merging portion 124. The second receiving section 134 may be configured to convey packages from the second upstream portion 112 downstream and/or toward the first receiving section 132. In some embodiments, the second receiving section 134 is substantially triangular (e.g., FIGS. 16A-16B).

The merging portion 124 includes a first frame member 136 extending along the first side 126 and a second frame member 138 along at least a portion of the second side 128. The first frame member 136 of the merging portion 124 may extend from the downstream end of the first frame member 104 of the first upstream portion 102. The first frame member 136 of the merging portion 124 may extend substantially in line with the first frame member 104 of the first upstream portion 102. The first frame member 136 of the merging portion 124 may be a continuation or extension of the first frame member 104 of the first upstream portion 102. The first frame member 136 of the merging portion 124 may extend to a height greater than the merge conveying surface 130 such that the first frame member 136 of the merging portion 124 may act as a guide rail for the merging portion 124 along the first side 126 which prevents packages from being conveyed laterally off the first side 126 of the merge conveying surface 130. While the first frame member 136 of the merging portion 124 has been described as being a separate component from the first frame member 104 of the first upstream portion 102, it will be understood that the first frame member 136 of the merging portion 124 and the first frame member 104 of the first upstream portion 102 may be combined into a single frame member.

The second frame member 138 of the merging portion 124 may extend from downstream end of the second frame member 116 of the second upstream portion 112. The second frame member 138 of the merging portion 124 may be a continuation or extension of the second frame member 116 of the second upstream portion 112. The second frame member 138 of the merging portion 124 may extend along the upstream portion 128a of the second side 128. The second frame member 138 may extend downstream and partially toward the first frame member 136 of the merging portion 124. The second frame member 138 of the merging portion 124 may include a wall section 138a extending downstream along the upstream portion 128a of the second side 128 from the downstream end of the second frame member 116 of the second upstream portion 112 and a rail section 138b extending downstream from the wall section 138a to the junction of the upstream and downstream portions 128a, 128b of the second side 128. The wall section 138a may extend to a height greater than the merge conveying surface 130 such that the wall section 138a may act as a guide rail along a portion of the second side 128 which prevents packages from being conveyed laterally off the portion of the second side 128 of the merging portion 124 surrounded by the wall section 138a. The wall section 138a may extend to substantially the same height as the second frame member 116 of the second upstream portion 102. The rail section 138b may extend to a height lower than the top surface of the rollers 122 in the merging portion 124 such that packages may be conveyed at least partially over the rail section 138b, as discussed below. While the second frame member 138 of the merging portion 124 has been described as being a separate component from the second frame member 116 of the second upstream portion 112, it will be understood that the second frame member 138 of the merging portion 124 and the second frame member 116 of the second upstream portion 112 may be combined into a single frame member.

In some embodiments, the merging portion 124 includes a third or intermediate frame member 140 disposed between the first and second sides 126, 128 of the merging portion 124. The third frame member 140 may extend from the intersection or merging of the second frame member 106 of the first upstream portion 102 and the first frame member 114 of the second upstream portion 112 to the junction of the upstream and downstream portions 128a, 128b of the second side 128 of the merging portion 124. The third frame member 140 may extend to a height lower than the top surfaces of the rollers 122 in the merging portion 124 such that packages may be conveyed over and/or along the third frame member 140. The third frame member 140 may define the intersection length L between the downstream ends of the first and second conveying surfaces 108, 118. The third frame member 140 may provide attachment points for rollers 122 in the merging portion 124, as discussed below. The third frame member 140 may also separate the first and second receiving sections 132, 134, as discussed below.

The first receiving section 132 may be configured to convey packages in substantially the same direction as the downstream portion of the first upstream portion 102. The first receiving section 132 may be configured to convey packages toward the downstream conveyor. The first receiving section 132 may be a continuation or extension of the first upstream conveying surface 108. The first receiving section 132 may extend between the first and third frame members 136, 140 of the merging portion 124. The first receiving section 132 may comprise a plurality of rollers 122 extending between the first and third frame members 136, 140 and may be disposed at an angle substantially perpendicular to the first and third frame members 136, 140. The rollers 122 in the first receiving section 132 may be disposed in substantially the same orientation as the rollers 122 of the downstream portion of the first upstream portion 102.

The second receiving section 134 may be configured to convey packages in substantially the same direction as the downstream portion of the second upstream portion 112. The second receiving section 134 may be configured to convey packages at least partially toward a downstream portion of the first receiving section 132. The second receiving section 134 may be a continuation or extension of the second upstream conveying surface 118. The second receiving section 134 may extend between the second frame member 138 (e.g., the upstream portion 128a of the second side 128) and the third frame member 140. The second receiving section 134 may comprise a plurality of rollers 122 extending between the third frame member 140 and the second frame member 138 of the merging portion 124. The rollers 122 in the second receiving section 134 may be disposed and configured to convey packages toward and along the wall section 138a of the second frame member 138 of the merging portion 124. The rollers 122 in the second receiving section 134 may be disposed at an angle substantially perpendicular to the second frame member 138 of the merging portion 124. In some embodiments, the rollers 122 in the second receiving section 134 are disposed in substantially the same orientation as the rollers 122 of the downstream portion of the second upstream portion 112.

The merging portion 124 may also include a consolidating section 142 downstream of the first and second receiving sections 132, 134 (e.g., downstream of the intersection length L) such that the consolidating section 142 may receiving packages conveyed along the first and second receiving sections 132, 134. The consolidating section 142 may extend between the first frame member 136 of the merging portion 124 and the downstream portion 128b of the second side 128. The third frame member 140 may extend downstream from the intersection length L along the downstream portion 128b of the second side 128 such that the third frame member 140 defines the downstream portion 128b of the second side 128 of the merging portion 124. The consolidating section 142 may include a plurality of rollers 122 extending between the first and third frame members 136, 140. The rollers 122 of the consolidating section may be disposed in substantially the same orientation as the rollers 122 of the first receiving section 132.

The third frame member 140 may be configured to prevent packages from moving laterally off the downstream end of the consolidating section 142 as packages are conveyed to the downstream conveyor. The third frame member 140 may also be configured to provide a buffer for package flow within the merging portion 124, as described below. The third frame member 140 may include a rail section 140b extending a distance downstream from the termination of the intersection length L and a wall section 140a extending downstream from the rail section 140b. The rail section 140b may extend to a height lower than the top surface of the rollers 122 in the consolidating section 142 such that packages may be conveyed over and/or along the rail section 140b, as discussed below. The wall section 140a may extend to a height greater than the rollers 122 of the consolidating section 142 such that the wall section 140a may act as a guide rail along the downstream portion of the consolidating section 142 which prevents packages from being conveyed laterally off the downstream portion of the consolidating section 142. While the third frame member 140 has been described as defining the downstream portion 128b of the second side 128 of the merging portion 124, it will be understood that the conveyor system 100 may have other configurations. For example, the third frame member 140 may only span the intersection length L and the second frame member 138 of the merging portion 124 may extend downstream of the intersection length L or an additional frame member may be utilized.

Referring to FIGS. 1-4 and 10-15, the conveyor system 100 may also include a guard rail 144 configured to decrease jamming in the merging portion 124. The guard rail 144 may be disposed along the second side 128 of the merging portion 124 of the conveyor system 100. The guard rail 144 is configured to allow packages conveyed near the second side 128 of the merge conveying surface 130 to temporarily slide at least partially onto the guard rail 144, such as to provide a lateral outlet or buffer to block or prevent potential package jams in the merging portion 124. The guard rail 144 may also be configured to direct packages at least partially disposed on the guard rail 144 back onto the merge conveying surface 130, such as via gravity. The guard rail 144 may be further configured such that packages may slide up the guard rail 144 from the merge conveying surface 130 and subsequently slide down the guard rail 144 onto the merge conveying surface 130 without flipping the packages and/or without the packages pinching or otherwise becoming stuck between the guard rail 144 and packages on the merge conveying surface 130.

In the illustrated embodiment, the guard rail 144 includes a ramp portion 146 configured to be disposed adjacent to the second side 128 of the merging portion 124. The ramp portion 146 may ramp upwardly from a height substantially equivalent to the merge conveying surface 130. The ramp portion 146 may ramp upwardly at an incline which allows packages to slide laterally from the merge conveying surface 130 and up along the ramp portion 146. The ramp portion 146 may also ramp upwardly at an incline which allows packages to slide back down the ramp portion 146 and back onto the merge conveying surface 130, such as after space has been created on the merge conveying surface 130. The ramp portion 146 may be substantially planar and extend upwardly from the merge conveying surface 130 at an angle between about 10 degrees and about 45 degrees, such as between about 20 degrees and about 30 degrees, such as about 25 degrees. However, it will be understood that the ramp portion 146 may have other shapes and configurations. For example, the ramp portion 146 may be curved or rounded upwardly.

The guard rail 144 also includes a wall portion 150 disposed opposite the merge conveying surface 130. The wall portion 150 may be configured to block or prevent packages from being conveyed off of the guard rail 144 from the side of the guard rail 144 opposite the merge conveying surface 130. The wall portion 150 may be substantially perpendicular to the merge conveying surface 130 (e.g., vertical). The wall portion 150 may extend to a height sufficient to prevent packages traveling up the ramp portion 146 from flipping over the wall portion 150.

The guard rail 144 may also include an intermediate ramp portion 148 disposed between the ramp portion 146 and the wall portion 150. The intermediate ramp portion 148 may be configured to direct packages at least partially on the guard rail 144 back toward the merge conveying surface 130 and/or to decelerate packages sliding laterally off the merge conveying surface 130 onto the guard rail 144. In some embodiments, the intermediate ramp portion 148 is configured to induce flipping of packages such that packages prone to flipping flip on the guard rail 144 and not over the wall portion 150.

The intermediate ramp portion 148 may extend from a top of the ramp portion 146 to a base of the wall portion 150. The intermediate ramp portion 148 may define a steeper incline than the ramp portion 146. The intermediate ramp portion 148 may also have a lateral width that is shorter than a lateral width of the ramp portion 146. A downstream portion of the intermediate ramp portion 148 may be configured or oriented to direct packages toward the merge conveying surface 130, as described below.

In the illustrated embodiment, the ramp portion 146, the intermediate ramp portion 148, and the wall portion 150 are discrete and substantially planar (e.g., flat). However, it will be understood that the guard rail 144 may have other suitable configurations. For example, all or some or the guard rail 144 may be curved or rounded such that the ramp portion 146 and/or the intermediate ramp portion 148 curve upwardly into the wall portion 150.

The guard rail 144 is configured to extend along a length of the second side 128 of the merging portion 124. The guard rail 144 may be angled or V-shaped. The guard rail 144 may be configured to extend at least partially along a length of the upstream portion 128a of the second side 128 and at least partially along a length of the downstream portion 128b of the second side 128. For example, the guard rail 144 may be configured and/or disposed to provide packages to at least partially slide onto the guard rail 144 from the second receiving section 134 and the consolidating section 142 to provide a buffer to prevent or otherwise reduce package jams in the merging portion 124.

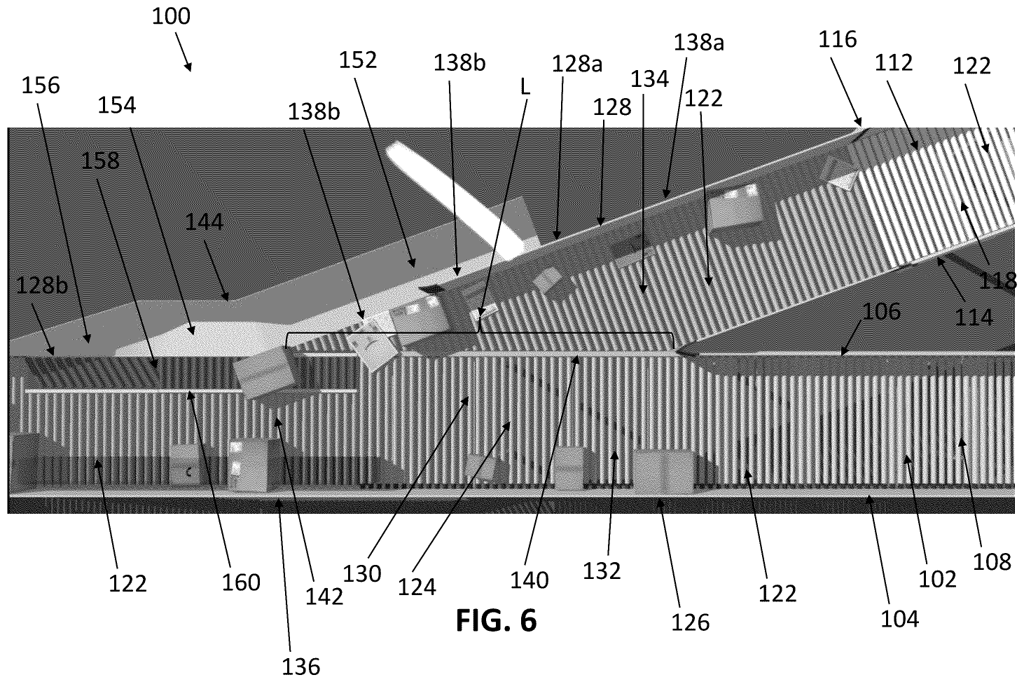

The guard rail 144 may include a first buffer portion 152 configured to extend along the upstream portion 128a of the second side 128 of the merging portion 124 at least partially downstream from the second upstream portion 112. The first buffer portion 152 is configured to at least partially receive packages conveyed from the second receiving section 134 of the merging portion 124. The first buffer portion 152 may be configured to extend upstream from the junction of the upstream and downstream portions 128a, 128b of the second side 128 of the merging portion 124. The first buffer portion 152 may be configured to extend along at least the length of the rail section 138b of the second frame member 138 of the merging portion 124. The first buffer portion 152 may be disposed such that packages may be conveyed from the second receiving section 134, at least partially over the rail section 138b of the second frame member 138, and at least partially onto the first buffer portion 152. For example, during periods of increased package flow into the merging portion 124, such as an increased package flow from the second upstream portion 112, packages which would otherwise jam against a guide rail of the merging portion 124 may slide over the rail section 138b of the second frame member 138 and at least partially onto the first buffer portion 152 of the guard rail 144. In some embodiments, the first buffer portion 152 is configured to extend at least partially along the wall section 138a of the second frame member 138 of the merging portion 124. For example, as shown in FIGS. 6-9, the first buffer portion 152 may extend at least partially behind the wall section 138a of the second frame member 138 such that packages do not fall off the conveyor system 100 when moved over the rail section 138b of the second frame member 138. In some embodiments, the first buffer portion 152 includes a side wall extending between the guard rail 144 and the wall section 138a of the second frame member to prevent packages from sliding upstream and off the guard rail 144.

The first buffer portion 152 may also be configured to redirect packages back toward the merge conveying surface 130, such as after space has become available on the merge conveying surface 130. For example, packages may at least partially ride up the first buffer portion 152 during periods of increased package flow and may subsequently slide down the first buffer portion 152 back to the merge conveying surface 130 after other packages have been conveyed downstream along the merging portion 124 such that the package may return to the merge conveying surface 130 without packages jamming.

The guard rail 144 may also include a converging portion 156 downstream of the first buffer portion 152. The converging portion 156 is configured to direct packages on the guard rail 144 toward the consolidating section 142 of the merging portion 124. For example, the converging portion 156 may be configured such that packages at least partially disposed on the guard rail 144 downstream of the first buffer portion 152 are pushed, biased, or otherwise directed onto the merge conveying surface 130. The converging portion 156 is configured to extend along at least a length of the rail section 140b of the third frame member 140 of the merging portion 124.

The converging portion 156 may be tapered toward the consolidating section 142 of the merging portion 124 in the downstream direction. For example, the converging portion 156 may have a first width at the upstream end and a second width at the downstream end, the first width being greater than the second width. The first width of the converging portion 156 may be substantially similar to a width of the first buffer portion 152. The wall portion 150 of the converging portion 156 may be tapered or angled toward the third frame member 140. The ramp portion 146 and the intermediate ramp portion 148 may be similarly angled or tapered laterally toward the third frame member 140. The converging portion 156 is configured such that packages at least partially disposed on the converging portion 156 are moved downwardly (e.g., lower height) and laterally to the merge conveying surface 130, such as along the wall portion 150, such that the entire package is moved onto the merge conveying surface 130.

In some embodiments, the wall portion 150 of the converging portion 156 is angled or otherwise configured such that the downstream end of the wall portion 150 is substantially adjacent to the third frame member 140 and the merge conveying surface 130. For example, the downstream end of the wall portion 150 of the converging portion 156 may be sufficiently close to the merge conveying surface 130 such that packages do not fall between the downstream end of the wall portion 150 and the merge conveying surface 130. The ramp portion 146 and intermediate ramp portions 148 may be angled toward the third frame member 140 proportionally with the wall portion 150.

In some embodiments, the intermediate ramp portion 148 of the guard rail 144 twists in the converging portion 156 to direct packages downwardly and laterally toward the merge conveying surface 130. The intermediate ramp portion 148 may be configured such that the downstream portion of the converging portion 156 is substantially helical or rounded. For example, the upstream end of the intermediate ramp portion 148 in the converging portion 156 may be substantially parallel to the intermediate ramp portion 148 in the first buffer portion 152 and the downstream end of the intermediate ramp portion 148 in the converging portion 156 may be substantially parallel to the wall portion 150 at the downstream end of the converging portion 156. When packages are conveyed downstream along the converging portion 156 of the guard rail 144, packages may slide along the intermediate ramp portion 148 such that the lateral taper of the intermediate ramp portion 148 directs packages laterally toward the merge conveying surface 130 and/or such that the steeper angle of the intermediate ramp portion 148 directs packages downwardly toward the merge conveying surface 130.

In the illustrated embodiment, the converging portion 156 is linearly tapered in the downstream direction. However, it will be understood that the converging portion 156 may have other configurations. For example, the converging portion 156, such as the wall portion 150, may be curved or rounded toward the second side 128 of the merging portion 124 to direct packages toward the merge conveying surface 130.

In some embodiments, the guard rail 144 also includes a second buffer portion 154 extending between the first buffer portion 152 and the converging portion 156. The second buffer portion 154 may be configured to extend downstream from the junction of the upstream and downstream portions 128a, 128b of the second side 128 of the merging portion 124. The second buffer portion 154 may be disposed such that packages may be conveyed from the second receiving section 134, the first receiving section 132, and/or the consolidating section 142, over the rail section 138b of the second frame member 138 and/or over the rail section 140b of the third frame member 140, and at least partially onto the second buffer portion 154. The second buffer portion 154 may also be configured to receive packages from the first buffer portion 152 which have not moved back onto the merge conveying surface 130.

The guard rail 144 may comprise materials and/or include one or more coatings which decrease the coefficient of friction of the upper surfaces of the guard rail 144. For example, upper surfaces of the ramp portion 146 and/or the intermediate ramp portion 148 may have a low coefficient of friction such that packages may easily slide up and down the ramp portion 146 and/or the intermediate ramp portion 148. In some embodiments, the guard rail 144 comprises metal (e.g., steel or aluminum), one or more polymers (e.g., plastic), or the like, or combinations thereof and/or includes a silicone treatment coating and/or other coating to reduce the coefficient of friction of the guard rail 144. In an exemplary embodiment, the guard rail comprises galvanized steel.

The guard rail 144 may be sized, shaped, and configured to correspond to the size, shape, and configuration of the merging portion 124. The first buffer portion 152 may be sized, shaped, and configured to correspond to the upstream portion 128a of the second side 128 and the second buffer portion 154 and the converging portion 156 may be sized, shaped, and configured to correspond to a length of the downstream portion 128b of the second side 128. The first buffer portion 152 may be angled relative to the second buffer portion 154 corresponding to the angle formed between the upstream and downstream portions 128a, 128b of the second side 128.

In the illustrated embodiment, the first buffer portion 152 has a length (e.g. portion along the upstream portion 128a of the second side 128) of about 106.65 inches, the second buffer portion 154 has a length (e.g., portion along the downstream portion 128b of the second side 128) of about 36 inches, and the converging portion 156 has a length (e.g., portion along the downstream portion 128b of the second side 128) of about 60 inches. The inner edge of the first buffer portion 152 (portion disposed along the upstream portion 128a of the second side 128) is disposed at an angle of 160 degrees from the inner edge of the second buffer portion 154 (portion disposed along the downstream portion 128b of the second side 160). However, it will be understood that the guard rail 144 may have other sizes, shapes, and configurations. For example, the guard rail 144 may be sized, shaped, and configured to correspond to the size and shape of the merge conveying surface 130.

The ramp portion 146 may have a width (e.g., length extending from the side of the merge conveying surface 130 to the base of the intermediate ramp portion 148) greater than a width of the intermediate ramp portion 148 (e.g., length extending from the side of the ramp portion 146 and the base of the wall portion 150. In the illustrated embodiment, the ramp portion 146 has a width of about 16 inches. The width of the intermediate ramp portion 148 may decrease in the converging portion 156

While the guard rail 144 has been described as including a ramp portion 146, an intermediate portion 148, and a wall portion 150, it will be understood that the guard rail 144 may have other suitable configurations. For example, the guard rail 144 may have only a ramp portion 146 and a wall portion 150, and the ramp portion 146 may be linear and/or rounded. Alternatively, the guard rail 144 may include additional planar portions of varying heights, widths, and orientations such that the guard rail 144 comprises a plurality of portions increasing in angle from being substantially flat near the second side 128 of the merging portion 124 to substantially vertical near the top of the guard rail 144 away from the merging portion 124 (e.g., near the wall portion 150). Further, while the guard rail 144 has been described as being included in the conveyor system 100, it will be understood that the guard rail 144 may be an independent component. For example, the guard rail 144 may be a separate component which may be retrofit onto a preexisting merging conveyor system to decrease package jamming in the merge conveyor.

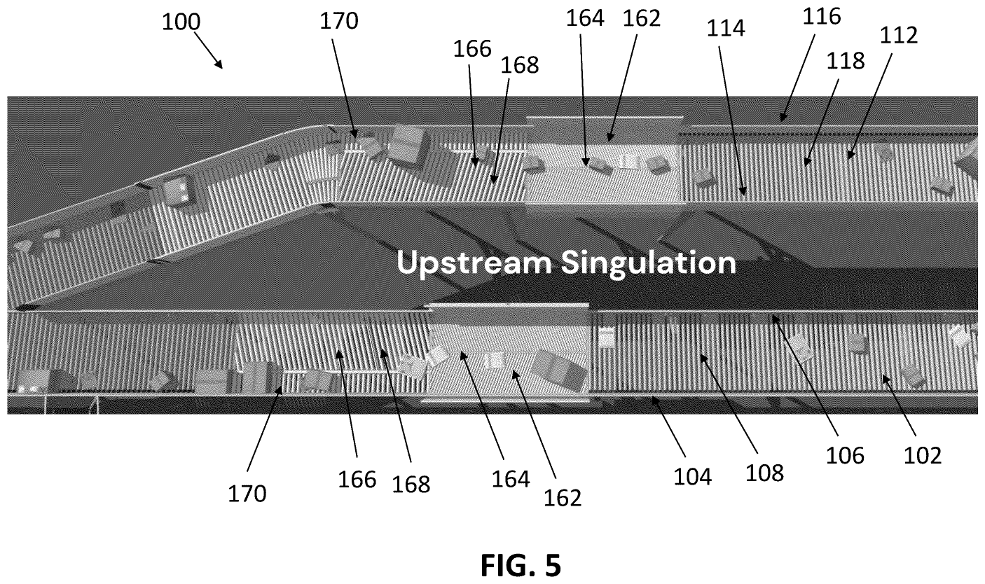

Referring now to FIGS. 5-9 and 20A-20B, in some embodiments, the conveyor system 100 includes a biasing section 158 configured to bias packages away from the guard rail 144 and/or the downstream portion 128b of the second side 128 of the merging portion 124. For example, the biasing section 158 may be positioned and configured to convey packages away from the downstream end of the guard rail 144 (e.g., the converging portion 156) such that packages at least partially disposed on the guard rail 144 may move entirely onto the merge conveying surface 130. The biasing section 158 may be disposed near the guard rail 144. In some embodiments, the biasing section 158 is disposed adjacent to the guard rail 144 and extends along a length of the guard rail 144, such as along the converging portion 156.

The biasing section 158 may include a plurality of rollers 122 configured to maneuver packages on the merge conveying surface 130 in a manner such that packages at least partially disposed on the guard rail 144 may be moved onto the merge conveying surface 130. For example, the biasing section 158 may convey or otherwise maneuver packages toward the first side 126 of the merging portion 124 and/or may maneuver packages along the downstream portion 128b of the second side 128 of the merging portion 124 to make space on the merge conveying surface 130 for packages to move from the guard rail 144 to the merge conveying surface 130. The biasing section 158 may also be configured to convey packages away from the guard rail 144, such as from the second buffer portion 154 and/or the converging portion 156, to prevent pinching or jamming at the downstream end of the guard rail 144 (e.g., the converging portion 156).

In some embodiments, the biasing section 158 includes a plurality of skewed rollers 122c configured to convey packages away from the guard rail 144. The skewed rollers 122c may be angled away from the second side 128 of the merging portion 124 (e.g., away from the guard rail 144) with the outer ends of the skewed rollers 122c (e.g., ends nearer to the second side 128 of the merging portion 124) disposed downstream of the inner ends of the skewed rollers 122c (e.g., ends opposite the second side 128 of the merging portion 124). The skewed rollers 122c may be disposed at any angle suitable to convey packages away from the downstream end of the guard rail 144. In some embodiments, the skewed rollers 122c are disposed at an angle between about 5 degrees and about 45 degrees.

The skewed rollers 122c may extend along a portion of the guard rail 144 along the downstream portion 128b of the second side 122. In some embodiments, the skewed rollers 122c extend along the converging portion 156 of the guard rail 144. The skewed rollers 122c of the biasing section 158 may be sized, shaped, and configured to such that the skewed rollers 122c end upstream of the downstream end of the converging portion 156 of the guard rail 144. For example, the skewed rollers 122c may be disposed upstream of the downstream end of the converging portion 156 such that packages may be conveyed from the downstream end of the converging portion 156 and be conveyed substantially along the downstream portion 128b of the second side 122.

In some embodiments, the biasing section 158 includes a plurality of lateral rollers 122d disposed upstream of the skewed rollers 122c in the biasing section 158. The lateral rollers 122d may be disposed substantially horizontally within the merging portion 124. The lateral rollers 122d may have a lateral width substantially corresponding to a lateral width of the skewed rollers 122c. In some embodiments, the lateral rollers 122d extend upstream of the second buffer portion 154 of the guard rail 144 (e.g., upstream of the junction of the upstream and downstream portions 128a, 128b of the second side 128 of the merging portion 124) and into the first receiving section 132 of the merging portion 124.

The lateral rollers 122d of the biasing section 158 may be disposed, configured, and operated to reorient packages conveyed along a portion of the second receiving section 134 to facilitate merging of packages in the consolidating section 142. When packages are conveyed from the second receiving section 134 to the lateral rollers 122d, the packages may turn or otherwise orient such that the packages are in line with the direction of travel (e.g., downstream along the first receiving section 132 and/or consolidating section 142) and to reduce the profile of the package in the merging portion 124. For example, packages may be conveyed in line with the rollers 122 of the second receiving section 134, contact the lateral rollers 122d, and turn to be in line with the lateral rollers 122d to square the packages up relative to the rollers 122 of the consolidating section 142 (e.g., to reduce the lateral and/or longitudinal space of the package on the rollers 122), and to ease the merging of packages within the merging portion 124. In some embodiments, the skewed rollers 122c and/or the lateral rollers 122d of the biasing section 158 may be operated at a lower speed than other sections of the merging portion 124.

In some embodiments, the merging portion 124 includes a biasing frame member 160 disposed between the first and third frame members 136, 140 of the merging portion 124. The biasing frame member 160 may provide attachment points for the skewed rollers 122c, the lateral rollers 122d, and some of the rollers 122 in the consolidating section 142. The biasing frame member 160 may maintain the orientation of the skewed rollers 122c, the lateral rollers 122d, and the respective rollers 122 in the consolidating section 142. The biasing frame member 160 may extend to a height lower than the top surfaces of the skewed rollers 122c, the lateral rollers 122d, and the respective rollers 122 in the consolidating section 142 such that packages may be conveyed over and/or along the biasing frame member 160, such as from side to side and/or upstream to downstream.

Referring now to FIGS. 1-2 and 17A-19B, in some embodiments, one or both of the upstream portions 102, 112 may be configured to orient, align, or otherwise maneuver packages on the respective upstream conveying surface 108, 118 before the merging portion 124 to facilitate the merging of packages from the first and second upstream 102, 112 without packages jamming in the merging portion 124. In some embodiments, one or both of the upstream portions 102, 112 are configured to singulate packages upstream of the merging portion 124. It will be understood that the terms “singulate,” “singulating,” and “singulation” encompass processes which maneuver packages toward a single file line along the direction of travel of the conveyor. In some embodiments, one or both of the upstream portions 102, 112 are configured to align packages with an outer edge or rail of the respective upstream portion 102, 112 upstream of the merging portion 124, such as to utilize substantially all of width of downstream portions of the merging portion 124 for merging packages.

One or both of the upstream portions 102, 112 may include a singulation section 162 configured to singulate packages. The singulation sections 162 may receive packages across a width of the respective upstream portion 102, 112 and direct or otherwise maneuver the packages toward a single file line. For example, the singulation sections 162 may be configured to break up or otherwise separate clusters of packages, such as by merging the packages toward a single file line.

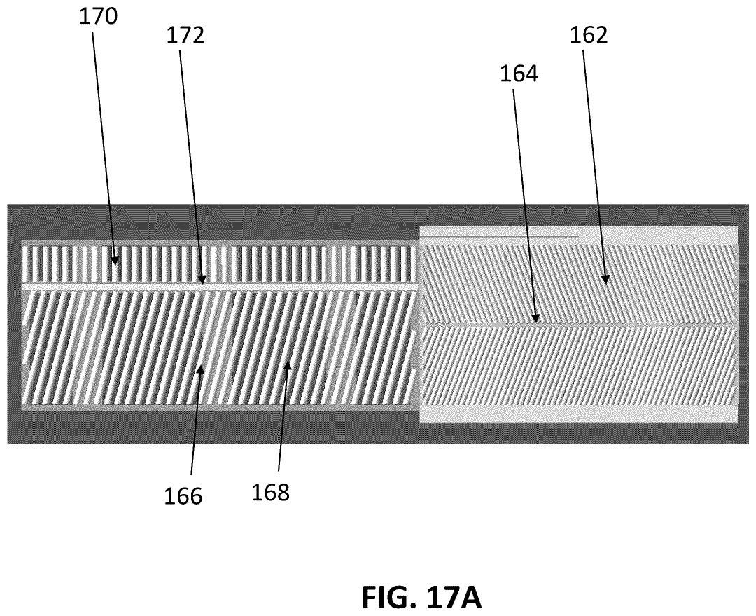

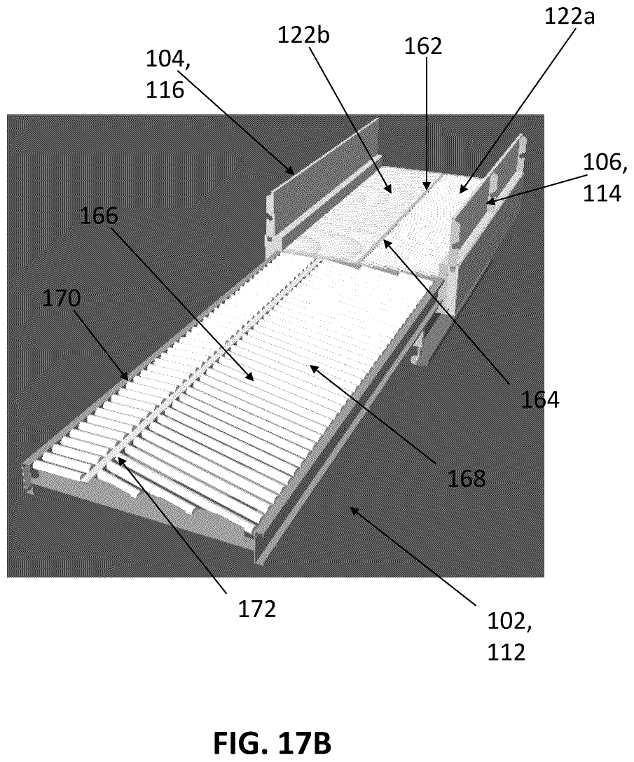

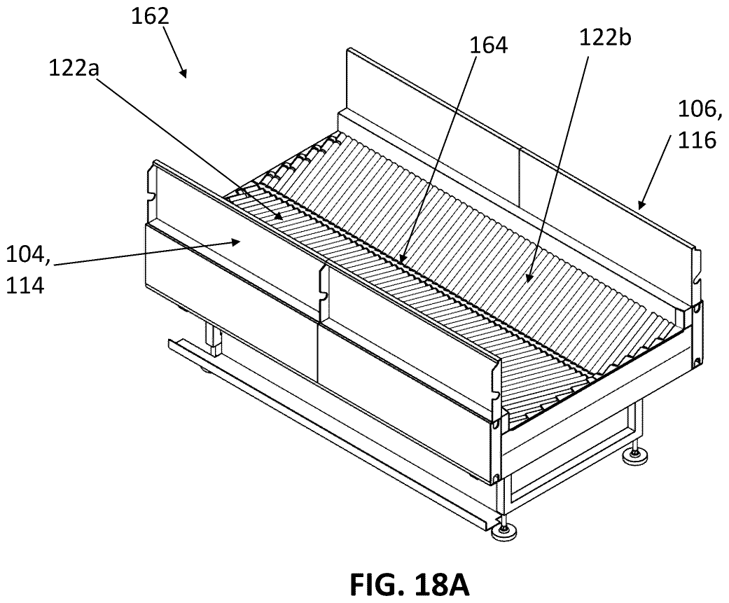

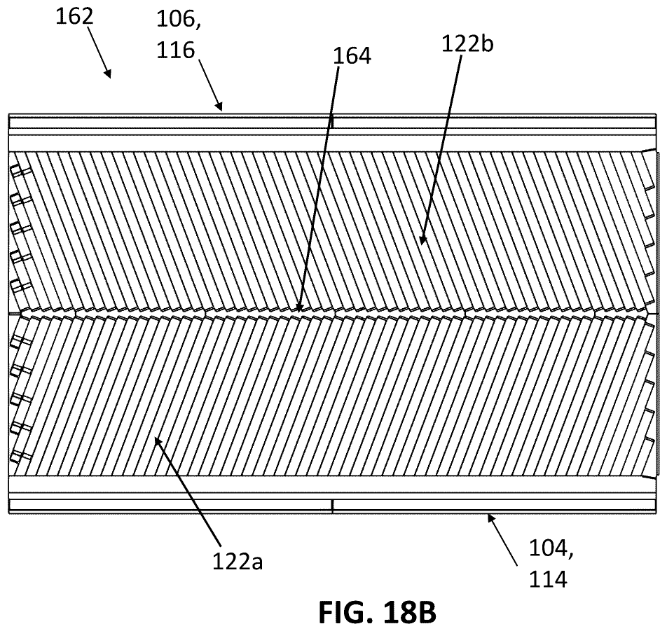

As shown in FIGS. 17A-18B, the singulation sections 162 each include a plurality of rollers 122 configured to direct packages toward a medial portion of the singulation section 162 to align the packages. The rollers 122 may be oriented (e.g., angled or skewed) to direct packages toward a portion of the singulation section 162 to singulate the packages. The rollers 122 may be oriented to direct the packages toward a medial (e.g., middle) portion of the singulation section 162.

In some embodiments, the singulation sections 162 includes a plurality of first rollers 122a disposed on a first side of the singulation section 162 (e.g., near the first frame member 104, 114) and a plurality of second rollers 122b disposed on a second side of the singulation section 162 opposite the first side of the singulation section 162 (e.g., near the second frame member 106, 116). The first rollers 122a may be oriented downstream and at least partially toward the second rollers 122 and the second rollers 122b may be oriented downstream and at least partially toward the first rollers 122a. The first and second rollers 122a, 122b may be oriented such that packages conveyed onto the first rollers 122a are conveyed downstream and toward the second rollers 122b and packages conveyed onto the second rollers 122b are conveyed downstream and toward the first rollers 122a. As packages are conveyed downstream through the singulation section 162 along the first and second rollers 122a, 122b, the packages may merge toward a medial portion (e.g., middle) portion such that the packages merge toward a substantially straight line. For example, packages may be conveyed via the first and second rollers 122a, 122b toward the center of the singulation section 162 such that the packages jostle to reduce the clustering of packages along a width of the singulation section 162, such as to form a single file line.

In some embodiments, the singulation sections 162 include a medial frame member 164 disposed between the respective first frame member 104, 114 and second frame member 106, 116. Each medial frame member 164 may provide attachment points for the first and second rollers 122a, 122b in the singulation section 162. The first rollers 122a may extend between the first frame member 104, 114 and the medial frame member 164 and the second rollers 122b may extend between the medial frame member 164 and the second frame member 106, 116. The medial frame member 164 may maintain the orientation of the first and second rollers 122a, 122b. The medial frame members 164 may extend to a height lower than the top surfaces of the first and second rollers 122a, 122b in the singulation section 162 such that packages may be conveyed over the medial frame members 164 such as from side to side and/or upstream to downstream. In some embodiments, the first frame members 104, 114 and second frame members 106, 116 extend to a greater height in the singulation sections 162, such as to further prevent packages from falling off the upstream portions 102, 112 within the singulation sections 162.

The first and second rollers 122a, 122b may be angled relative to one another such that packages are conveyed substantially along the medial frame member 164. The first and second rollers 122a, 122b may angled such that the outside portion of the first and second rollers 122a, 122b (e.g., portions near first frame members 104, 114 or second frame members 106, 116) are downstream of the inside portion of the first and second rollers 122a, 122b (e.g., portions near the medial frame member 164). The outside portion of the rollers 122a, 122b may be disposed downstream at an angle relative to the inside portion (e.g., the angle between the roller 122a, 122b and the width of the singulation section 162) between about 5 degrees and about 60 degrees, such as between about 20 degrees and about 50 degrees, such as about 45 degrees. However, it will be understood that the first and second rollers 122a, 122b may be disposed in different orientations. For example, the first rollers 122a may be angled differently than the second rollers 122b.

While the singulation sections 162 have been described as include two sets of angled rollers 122a, 122b configured to maneuver packages, it will be understood that the singulation section 162 may have other configurations. For example, the singulation section 162 may include a first set of rollers configured to convey packages downstream (e.g., along one side of the singulation section 162) and a second set of rollers configured to convey packages downstream and/or toward the first set of rollers, or the singulation section 162 may include a single set of rollers configured to convey packages downstream and toward one of the sides of singulation section 162. Further, while the singulation sections 162 have been described as including a plurality of oppositely angled rollers 122 configured to singulate packages, it will be understood that the singulation sections 162 may have other configurations. For example, the singulation sections 162 may include driven belts, angled wheels, or other suitable mechanisms, or any combination thereof for singulating packages.

In the illustrated embodiment, the first and second upstream portions 102, 112 each include a singulation section 162. However, it will be understood that the conveyor system 100 may have other configurations. For example, only the first upstream portion 102 or only the second upstream portion 112 may include a singulation section 162.

Referring now to FIGS. 1-2, 17A-17B, and 19A-18B, one or both of the upstream portions 102, 112 may include an alignment section 166 configured to direct packages toward the one side of the upstream conveying surfaces 108, 118, such as the outer side of the respective upstream portion 102, 112 (e.g., along the first frame member 104 of the first upstream portion 102 and along the second frame member 116 of the second frame portion 112). The alignment sections 166 may be disposed upstream of the convergence of the upstream portions 102, 112 in the merging portion 124. The alignment sections 166 may be configured to direct or otherwise maneuver packages to the outer sides of the upstream conveying surfaces 108, 118 to reduce interference between packages conveyed by the first upstream portion 102 and packages conveyed by the second upstream portion 112 when the packages are merged in the merging portion 124. For example, the alignment section 166 of the first upstream portion 102 may be configured to maneuver packages toward the first side 126 of the merging portion 124 and the alignment section 166 of the second upstream portion 112 may be configured to maneuver packages toward the second side 128 of the merging portion 124. In some embodiments, the alignment sections 166 are downstream of the singulation section 162 such that packages are singulated and then maneuvered by the alignment sections 166.

Each alignment section 166 may include a plurality of rollers 122 configured to direct packages toward an outer side of the respective upstream conveying surface 108, 118 (e.g., along the first frame member 104 of the first upstream portion 102 and along the second frame member 116 of the second frame portion 112). In some embodiments, the alignment sections 166 may include an angled lane 168 configured to direct packages toward the outer side of the respective upstream conveying surface 108, 118. Each angled lane 168 may include a plurality of rollers 122 configured to maneuver packages toward the outer side of the upstream conveying surface 108, 118. The rollers 122 in the angled lane 168 may be angled to convey packages toward the outer side of the upstream conveying surface 108, 118, such as along the outer frame member 104, 116. The rollers 122 in the angled lane 168 may be angled with the inner ends (e.g., end nearer to the second frame member 106 of the first upstream portion 102 or end nearer to the first frame member 114 of the second upstream portion 112) disposed downstream of the outer ends (e.g., end nearer to the first frame member 104 of the first upstream portion 102 or end nearer to the second frame member 116 of the second upstream portion 112). The rollers 122 in the angled lane 168 may be oriented such that each roller 122 extends downstream from the outer end toward the inner end at an angle between about 45 degrees and about 85 degrees, 60 degrees and about 80 degrees, such as about 75 degrees.

In some embodiments, the alignment section 166 also includes a linear lane 170 configured to conveyed packages downstream along the upstream conveying surface 108, 118, such as downstream along the outer frame member 104, 116. The linear lane 170 may include a plurality of rollers 122 configured to convey packages substantially downstream. In some embodiments, the rollers 122 in the linear lane 170 are substantially horizontal across the upstream portion 102, 112. In other embodiments, the rollers 122 in the linear lane 170 are slightly angled, such as slightly angled away from the outer frame member 104, 116.

In some embodiments, the alignment sections 166 include a separating frame member 172 disposed between the respective first frame member 104, 114 and second frame member 106, 116. Each separating frame member 172 may provide attachment points for the rollers 122 of the angled lane 168 and the linear lane 170. The rollers 122 of the linear lane 170 may extend between the outer frame member 104, 116 and the separating frame member 172 and the rollers 122 of the angled lane 168 may extend from the separating frame member 172 to the inner frame member 106, 114. The separating frame member 172 may at least partially maintain the orientation of the rollers 122 in the linear lane 170 and the rollers 122 in the angled lane 168. The separating frame member 172 may extend to a height lower than the top surfaces of the rollers 122 in the alignment section 166 such that packages may be conveyed over the separating frame member 172, such as from side to side and/or upstream to downstream.

In operation, packages may be conveyed onto the alignment section 166 and packages may be conveyed from the angled lane 168 toward the linear lane 170. The linear lane 170 may convey packages downstream toward the merging portion 124. However, it will be understood that the alignment sections 166 may have other configurations. For example, the alignment section 166 may not include a linear lane 170 such that the rollers 122 of the alignment section 166 convey packages toward the outer frame member 104, 116 and downstream toward the merging portion 124. Further, while the alignment sections 166 have been described as including a plurality of rollers 122 configured to maneuver packages, it will be understood that the alignment sections 166 may have other configurations. For example, the alignment sections 166 may include angled belts, angled skate wheels, angled biasing members, angled mechanical biasing members (e.g., angled rails), or the like, or any combination thereof to direct packages to one side of the upstream conveying surface 108, 118.

In the illustrated embodiment, the first and second upstream portions 102, 112 each include an alignment section 166. However, it will be understood that the conveyor system 100 may have other configurations. For example, only the first conveyor section 102 or only the second conveyor section 112 may include an alignment section 166.

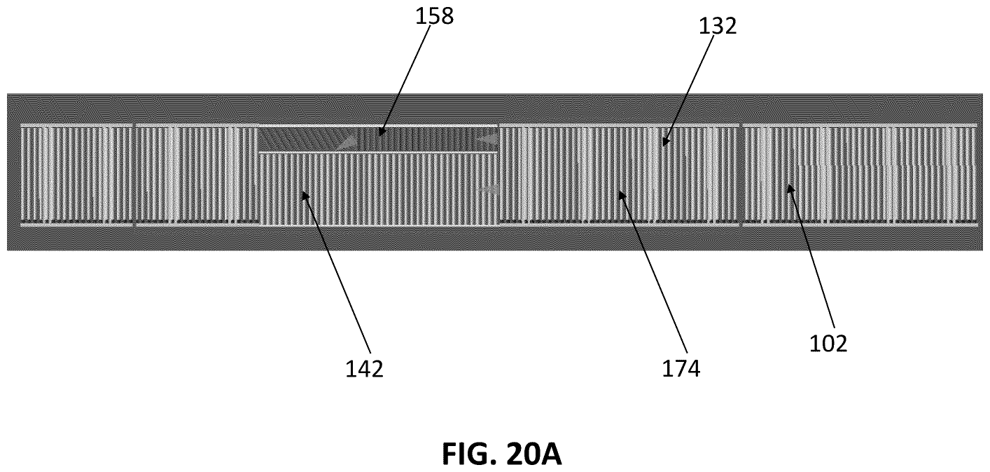

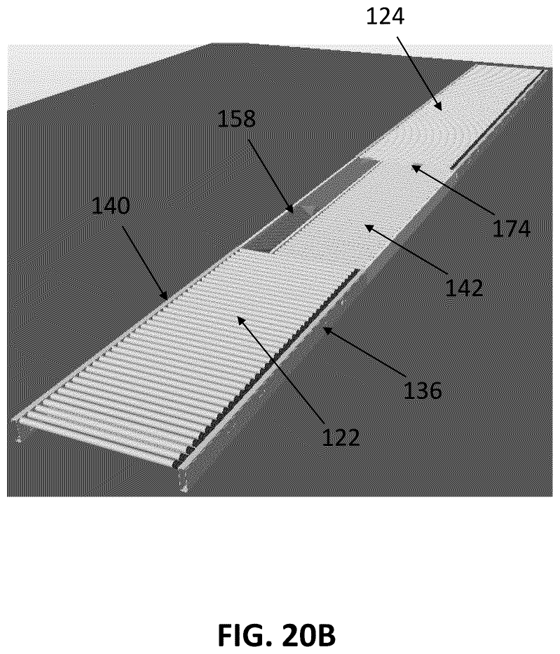

In some embodiments, as shown in FIG. 20A-20B, the conveyor system 100 may include one or more speed increase sections 174 configured to increase the conveyed speed of the packages disposed thereon. The speed increase sections 174 may be configured to increase the conveyance speed of packages conveyed thereon relative to packages conveyed along other portions of the conveyor system 100. The speed increase sections 174 may increase the speed of packages conveyed from one of the upstream portions 102, 112 to facilitating the merging of packages in the consolidating section 142 of the merging portion 124. The speed increase sections 174 may be disposed and configured to increase the speed of packages such that the packages conveyed by the speed increase sections 174 blend more seamlessly with other packages at a downstream location, such as to decrease jams.

In some embodiments, the rollers 122 in the speed increase sections 174 are driven at a higher rate (e.g., higher rpm) than other portions of the conveyor system 100. However, it will be understood that the speed increase sections 174 may increase the speed of the conveyed packages in other suitable manners. For example, in embodiments utilizing gravity to convey the packages, the speed increase sections 174 may include a steeper decline to increase the speed of the packages.

In some embodiments, the speed increase sections 174 increase the speed of the conveyed packages to a rate between about 1.25 and about 4.0 times faster than other portions of the conveyor system 100, such as between about 1.50 and about 3.0 times faster than other portions of the conveyor system 100, such as between about 1.75 and about 2.0 times faster than other portions of the conveyor system 100. For example, the majority of the conveyor system 100 may be operated or driven at a rate of about 131 feet per minute (e.g., packages traveling on the conveyor travel laterally at 131 feet per minute) and the speed increase sections 174 may be operated or driven at a rate of about 250 feet per minute.

In some embodiments, the speed increase sections 174 are disposed to convey packages from the first upstream portion 102 at a faster rate than packages from the second upstream portion 112. The speed increase sections 174 may be disposed in line with the first upstream portion 102 such that packages conveyed from the first upstream portion 102 move faster than (e.g., shoot past) packages conveyed second upstream portion 112. The speed increase sections 174 may also be positioned and configured to increase the speed of packages conveyed from the second upstream portion 102 that cross an upstream portion of the intersection length L to the first receiving section 132.

In some embodiments, the first receiving section 132 of the merging portion 124 includes or comprises one of the speed increase sections 174. In some embodiments, the consolidating section 142, such as the consolidating section 142 near the first frame member 136, may also include or comprise one of the speed increase sections 174. In some embodiments, the downstream portions of the first upstream conveying surface 108 also includes or comprises one of the speed increase section 174. However, it will be understood that the conveyor system 100 includes any suitable number of speed increase sections 174 and the speed increase sections 174 may be disposed in any suitable locations within the conveyor system 100. Further, it will be understood that the conveyor system 100 may not include specific speed increase sections 174 and one or more individual rollers 122 (or groups of rollers 122) may be driven at an increased rate to increase the speed of conveyed packages to facilitate the merging of packages.

In operation, packages may be received from a first upstream conveyor via the first upstream portion 102 along the first upstream conveying surface 108 and from a second upstream conveyor via the second upstream portion 112 along the second upstream conveying surface 118. The packages may be directed to the singulation sections 162 of the first and second upstream portion 102, 112 to break up package clusters and maneuver the packages toward a single file line. The packages may then be directed to the alignment sections 166 of the first and second upstream portions 102, 112 to maneuver the packages toward the outer sides of the upstream conveying surfaces 108, 118 (e.g., toward the outer frame members 104, 116), such as to direct packages driven by the first upstream portion 102 to be conveyed along one side of the consolidating section 162 and to direct packages driven by the second upstream portion 112 to be conveyed along a second side of the consolidating section 162 to facilitate merging of packages. The packages on the first upstream conveying surface 108 are directed to the first receiving section 132 of the merging portion 124 and the packages on the second upstream conveying surface 118 are directed to the second receiving section 134 of the merging portion 124. The conveyance speed of packages on the first upstream conveying surface 108 may be increased via one or more speed increase sections 174 in the first upstream conveying surface 108, the first receiving section 132, and/or the consolidating section 142. The conveyance speed of the packages from the first upstream conveying surface 108 may be increased to move ahead of packages from the second upstream conveying surface 118 to enhance package merging.

The packages from the first conveying surface 108 may be driven through the first receiving section 132 and the consolidating section 142 of the merging portion 124 (e.g., along the first frame member 136). The packages from the second conveying surface 118 may be driven into the second receiving section 134 of the merging portion 124. Some of the packages in the second receiving section 134 may be driven across the intersection length L and onto the first receiving section 132. The packages crossing the intersection length L may reorient upon crossing the intersection length L such that the packages substantially square up with and are in line with the conveyance direction of the first receiving section 132, such as to decrease the conveyance profiles of the packages. During periods of increased package flow, some packages in the second receiving section 134 and/or some of the packages in the first receiving section 132 (e.g., near the second side 128 of the merging portion 124) may at least partially slide onto the guard rail 144, such as onto the ramp portion 146 or intermediate ramp portion 148 along the first or second buffer portions 152, 154. The guard rail 144 may provide a temporary buffer space which prevents or reduces jams in the merging portion 124. Packages in the consolidating section 142 near the second side 128 of the merging portion 124 may be biased toward the first frame member 136 of the merging portion via the biasing section 158, such as to create space in the consolidating section 142 near the second side 128. The packages at least partially disposed on the guard rail 144 may slide back onto the merging conveying surface 130, such as after potential jams have been alleviated. The merged packages (e.g., packages from both upstream portions 102, 112) may then be driven downstream along the consolidating section 142 to a downstream conveyor.

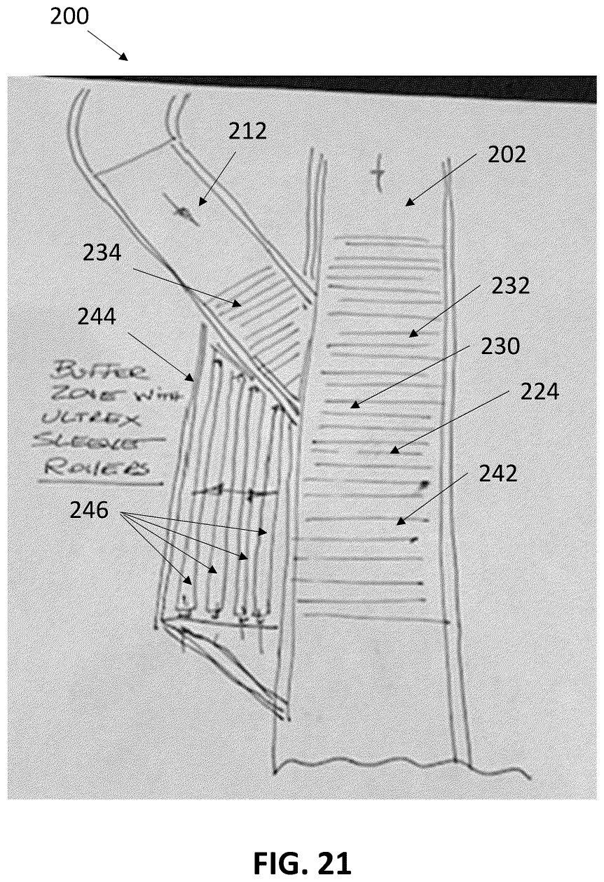

Referring now to FIG. 21, a merge conveyor system 200 according to another embodiment is shown. The merge conveyor system 200 is also configured to reduce package jamming in a small footprint, without complex controls, and in a cost-effective manner. The merge conveyor system 200 may incorporate any of the various features discussed above. The merge conveyor system 200 includes a first upstream portion 202 configured to receive packages from a first upstream conveyor and a second upstream portion 212 configured to receive packages from a second upstream conveyor. The merge conveyor system 200 includes a merging portion 224 downstream of the first and second upstream portions 202, 212 and including a merging conveying surface 230. The merging portion 224 is configured to merge packages conveyed from the first and second upstream portions 202, 212 and convey the merged packages to a downstream conveyor. The first and second upstream portions 202, 212 and the merging portion 224 may have any configurations and features discussed above in relation to any of the first and second upstream portions 102, 112 and/or to any of the merging portions 124. For example, the merging portion 224 may have a first receiving section 232 configured to receive packages from the first upstream portion 202, a second receiving section 234 configured to receive packages from the second upstream portion 212, and a consolidating section 242 configured to receive and merge packages from the first and second receiving sections 232, 234.

The conveyor system 200 also includes a guard buffer 244 configured to provide a temporary overflow path for packages in the merging portion 224 during periods of increased package flow. The guard buffer 244 may extend along a downstream, outer side of the second receiving section 232 and along an upstream, corresponding side of the consolidating section 242. Similarly to the conveyor system 100 described above, packages may at least partially slide from the merging conveying surface 230 onto the guard buffer 244. For example, packages may slide from the second receiving section 234, the first receiving section 232, and/or the consolidating section 242 onto the guard buffer 244 during periods of increased package flow. Packages may also move from the guard buffer 244 onto the second receiving section 234, the first receiving section 232, and/or the consolidating section 242 after other packages have moved downstream to resume conveyance to the downstream conveyor.

The guard buffer 244 includes a plurality of guard rollers 246 configured to direct packages back onto the second receiving section 234, the first receiving section 232, and/or the consolidating section 242. The guard rollers 246 may be cylindrical, spaced apart rollers disposed substantially perpendicular to the consolidating section 242. The guard rollers 246 may be driven, such as by a belt, motor, drive, or the like, to rotate toward the consolidating section 242. The guard rollers 246 may be driven at a rate slower than other rollers in the system 200 to direct packages back toward the second receiving section 234, the first receiving section 232, and/or the consolidating section 242. In some embodiments, the guard rollers 246 are driven at a speed between about 20 feet per minute and about 40 feet per minute toward the consolidating section 242. In some embodiments, the guard rollers 246 are substantially level with the consolidating section 242.

The guard rollers 246 may be configured such that one or more jammed packages (e.g., clusters of packages which would ordinarily cause a jam) may temporarily move in a direction opposite of the normal travel direction (e.g., slide) onto the guard rollers 242 and subsequently be moved (e.g., driven) toward the consolidating section 242 via frictional contact with the guard rollers 246. In some embodiments, the guard rollers 246 include a coating or sleeve, such as a loose plastic material, configured for low pressure roller accumulation. The coating or sleeve may modify the frictional interface of the guard rollers 246 with the packages to allow the packages to slide opposite the direction of travel, such as during periods of increased packages flow, and to drive packages toward the consolidating section 242, such as after clusters of packages have been conveyed downstream. The guard rollers 246 may also be configured to maneuver and/or re-introduce packages toward the consolidating section 242 without rotating the packages. Further, the guard buffer 244 and/or the guard rollers 246 may slow the conveyance of packages from the second receiving section 234, the first receiving section 232, and/or the consolidating section 242 before being driven toward the consolidating section 242 such that the linear length (e.g., upstream to downstream) of the guard buffer 244 may be decreased.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

We claim:

1. A merge conveyor system for merging packages from a first upstream conveyor and a second upstream conveyor, the merge conveyor system comprising:
a first upstream portion configured to convey packages from the first conveyor along a first upstream conveying surface;
a second upstream portion configured to convey packages from the second conveyor along a second upstream conveying surface;
a merging portion configured to receive packages from the first and second upstream portions, the merging portion having a first receiving portion near a first side, a second receiving portion near a second side, and a consolidating section downstream of the first and second receiving portions; and
a guard rail disposed along a portion of the second side and configured to provide a temporary overflow path for packages during periods of increased package flow.

2. The conveyor system according to claim 1, wherein at least one of the upstream portions comprises a singulation section configured to break up package clusters.

3. The conveyor system according to claim 1, wherein at least one of the upstream portions comprises an alignment section configured to direct packages toward an outer side of the respective upstream conveying surface.

4. The conveyor system according to claim 1, wherein the consolidating section includes a biasing section configured to maneuver packages away from the guard rail.

5. The conveyor system according to claim 1, wherein an intersection length extends between the first receiving section and the second receiving section.

6. The conveyor system according to claim 1, further comprising one or more speed increase sections along at least one of the first upstream conveying surface, the first receiving section, and the consolidating section to increase a conveyance speed of packages.

7. The conveyor system according to claim 1, wherein the guard rail is configured to reduce package jams in the merging portion.

8. A guard rail for use in a merge conveyor having at least one side, the guard rail comprising:
a first buffer portion configured to extend along an upstream portion of a side of the merge conveyor;
a converging portion configured to extend along a downstream portion of the side of the merge conveyor;
a ramp portion configured to extend along the side of the merge conveyor and permit packages to temporarily slide off the conveyor and at least partially onto the ramp portion; and
a wall portion disposed on a side of the guard rail opposite the merge conveyor and configured to block packages from flipping over the guard rail.

9. The guard rail according to claim 8, further comprising a second buffer portion disposed between the first buffer portion and the converging portion.

10. The guard rail according to claim 8, wherein the converging portion is tapered toward the side of the merge conveyor.

11. The guard rail according to claim 8, further comprising an intermediate ramp portion between the ramp portion and the wall portion.

12. The guard rail according to claim 11, wherein a surface of the intermediate portion twists in the converging portion.

13. The guard rail according to claim 8, wherein packages disposed at least partially on at least one of the ramp portion and the intermediate ramp portion slide to a conveying surface of the conveyor via gravity.

14. The guard rail according to claim 8, wherein the ramp portion is planar in at least one of the first buffer portion and the second buffer portion.

15. A merge conveyor system for merging packages from a first upstream conveyor and a second upstream conveyor, the merge conveyor system comprising:
a first upstream portion configured to convey packages from the first conveyor along a first upstream conveying surface;
a second upstream portion configured to convey packages from the second conveyor along a second upstream conveying surface;
a merging portion having a first receiving portion near a first side and configured to receive packages from the first upstream portion, a second receiving portion near a second side and configured to receive packages from the second upstream portion, an intermediate frame member disposed between the first and second sides, and a consolidating section downstream of the first and second receiving portions; and
a guard rail disposed along a portion of the second receiving portion and a portion of the consolidating section, the guard rail configured to provide a temporary overflow path for packages;
wherein a portion of the guard rail is aligned with the intermediate frame member.

16. The conveyor system according to claim 15, wherein the first and the second receiving portions each include a plurality of rollers, the rollers in the first receiving portion being perpendicular to the intermediate frame member and the rollers in the second receiving portion being non-perpendicular to the intermediate frame member.

17. The conveyor system according to claim 15, wherein the guard rail includes a first buffer portion, a second buffer portion, and a converging portion, the first buffer portion being aligned with the second receiving section and the second buffer portion and the converging portion being aligned with the consolidating section.

18. The conveyor system according to claim 15, wherein the guard rail is configured to direct received packages toward the consolidating section.

19. The conveyor system according to claim 15, wherein each of the upstream portions include a singulation section configured to merge packages toward a single file line and an alignment section configured to direct packages toward an outer side of the upstream conveying surface.

20. The conveyor system according to claim 15, further comprising a biasing section extending along a downstream portion of the guard rail and configured to convey packages away from the downstream portion of the guard rail.
